(19) United States
(12) Patent Application Publication
(10) Pub. No.: US 2025/0315791 A1
(43) Pub. Date: Oct. 9, 2025

(54) COMPUTING ACTION SEARCH USING NATURAL LANGUAGE PROCESSING

(71) Applicant: ADP, Inc., Roseland, NJ (US)

(72) Inventors: Brian C. Simms, Jersey City, NJ (US); Ruchi Jinendra Jain, Brooklyn, NY (US); Gabriel Rojas, Forest Hills, NY (US); Kunal Daral, North Bergen, NJ (US); Jiabo Li, Syosset, NY (US)

(73) Assignee: ADP, Inc., Roseland, NJ (US)

(21) Appl. No.: 19/173,377

(22) Filed: Apr. 8, 2025

Related U.S. Application Data
(60) Provisional application No. 63/631,859, filed on Apr. 9, 2024.

(51) Int. Cl. G06Q 10/105; G06F 16/3329; H04L 9/40

(52) U.S. Cl. CPC G06Q 10/105; G06F 16/33295; H04L 63/083

(57) ABSTRACT

The technical solutions described herein present a computing action search using natural language processing. A system can identify a request containing an executable action associated with a first account identifier of a client system and select a prompt that corresponds to the action, is structured as text including fields, and identifies compatible actions corresponding to the client system or the first account identifier. The system can embed content, including text or metadata, of the first account identifier into the fields of the prompt. The system can provide the prompt to a model and obtain a response from the model indicating a recommended action and a second account identifier associated with the recommended action. The system can validate that the recommended action corresponds to the compatible actions, and the second account identifier corresponds to the first account identifier and execute, responsive to validation, the recommended action for the first account identifier.

### CROSS REFERENCE TO RELATED APPLICATIONS

This application claims the benefit of and priority to, under 35 U.S.C. § 119, U.S. Provisional Application No. 63/631,859, filed Apr. 9, 2024, the entire disclosure of which is hereby incorporated by reference herein.

### TECHNICAL FIELD

This application is generally related to computing technology, and particularly to querying or searching for computing actions or commands using natural language processing.

### BACKGROUND

A computing system can be instructed to perform various actions through computer code. Due to the large number of actions that can be performed by a computing system, it can be challenging or error prone to for the computer system to efficiently and reliably search for a particular action, or process instructions to perform such action, thereby introducing delays, latency, or utilizing unnecessary or excessive computing resources when incorrect actions are processed, selected or performed by the computing system.

### SUMMARY

Aspects of technical solutions described herein are directed to a system to search for and perform computing actions using natural language processing. The system can efficiently and reliably perform desired actions responsive to receiving natural language prompts. This significantly reduces the time and resources consumed by computing systems or users in searching for and discovering how and where to perform actions in a large enterprise application or computing platform.

For example, attempting to determine user intentions surrounding an action using fuzzy matching can result in inaccurate determinations of the action. Moreover, custom language models may not perform well on searches associated with certain domains of data, such as searching for actions to perform on an enterprise software platform. Thus, the technical solutions described herein can provide a service provider system that is configured to accurately detect an intent of a query in an efficient manner, thereby providing an improved user experience that minimizes or prevents technical problems associated with hallucinations of models trained with machine learning, conserve processing and networking resources, and improve the system's overall reliability and performance. To do so, the service provider system can search for actions using a predetermined or preset list of actions. The service provider system can provide the preset list of actions in a prompt, which can be input to a model trained with machine learning (e.g., a large language model). The service provider system can validate the output of the model trained with machine learning based on capabilities of or metadata from an external system from which a query is obtained.

Therefore, at least one technical solution for executing smart search actions is introduced to tackle the issue of hallucinations in models trained with machine learning. This solution employs a predefined or preset list of actions within the prompt, allowing the model to select from these options. Additionally, the solution validates the model's output based on the capabilities or metadata from an external system where the query originates.

An aspect of the technical solutions described herein is directed to a system. The system can include one or more processors, coupled with memory. The one or more processors can be configured (e.g., via instructions and data stored in memory) to identify a request to execute an action associated with a first account identifier of a client system. The one or more processors can be configured to select a prompt that corresponds to the action, the prompt structured as text including one or more fields, the prompt identifying a list of compatible actions corresponding to at least one of the client system or the first account identifier. The one or more processors can be configured to embed content of the first account identifier into one or more of the fields of the prompt, the content including at least a portion of the text or a least a portion of a metadata. The one or more processors can be configured to provide, to a model trained with machine learning, the prompt embedded with the content. The one or more processors can be configured to obtain, from the model, a response to the prompt that indicates a recommended action, and a second account identifier associated with the recommended action. The one or more processors can be configured to validate that the recommended action corresponds to at least one of the compatible actions, and the second account identifier corresponds to the first account identifier. The one or more processors can be configured to execute the recommended action for the first account identifier in response to the validation of the recommended action and the second account identifier.

In some aspects, the one or more processors can be further configured to construct a vector using the action. The one or more processors can be further configured to construct a plurality of vectors using the prompt. The one or more processors can be further configured to compare the vector constructed using the action with the plurality of vectors constructed using the prompt. The one or more processors can be further configured to determine, based on the comparison, the list of compatible actions corresponding to the action.

In some aspects, the one or more processors can be further configured to obtain, from the model, an intent of the prompt. The one or more processors can be further configured to select, based on the intent, an index from a plurality of indexes. The one or more processors can be further configured to provide the index to the model to cause the model to generate a response that includes the index instead of the intent.

In some aspects, the one or more processors can be further configured to obtain, from the model, a response to the prompt that indicates the recommended action, the second account identifier associated with the recommended action and the index.

In some aspects, the one or more processors can be further configured to identify a network security parameter of the client system. The one or more processors can be further configured to compare the network security parameter with the first account identifier and the action. The one or more processors can be further configured to determine, based on the comparison, the action is authorized.

In some aspects, the one or more processors can be further configured to train the model with data from the client system.

In some aspects, the one or more processors can be further configured to identify, using the model, one or more data points associated with the action. The one or more processors can be further configured to validate that the one or more data points corresponds to the action. The one or more processors can be further configured to execute, using at least one of the one or more data points, the recommended action for the first account identifier in response to the validation of the recommended action and the second account identifier.

In some aspects, the one or more processors can be further configured to provide, to the model trained with machine learning, the prompt including the content and one or more historical responses to prompts. The one or more processors can be further configured to obtain, from the model, a response to the prompt that indicates a recommended action and second account identifier associated with the recommended action.

In some aspects, the one or more processors can be further configured to format the response to the prompt based on the client system.

In some aspects, the techniques described herein relate to a system, wherein the first account identifier corresponds to a profile data structure of an individual of an organization associated with the client system.

In some aspects, the techniques described herein relate to a system, wherein the action corresponds to a human resources activity, and the compatible actions correspond to human resource activities supported by a service provider system.

In some aspects, the techniques described herein relate to a method. The method can be performed by one or more processors, coupled with memory. The method can include identifying, by one or more processors, a request to execute an action associated with a first account identifier of a client system. The method can include the one or more processors selecting, by one or more processors, a prompt that corresponds to the action, the prompt structured as text including one or more fields, the prompt identifying a list of compatible actions corresponding to at least one of the client system or the first account identifier. The method can include the one or more processors embedding, by one or more processors, content of the first account identifier into one or more of the fields of the prompt, the content including at least a portion of the text or a least a portion of a metadata. The method can include the one or more processors providing, by one or more processors, to a model trained with machine learning, the prompt including the content. The method can include the one or more processors obtaining, by one or more processors, from the model, a response to the prompt that indicates a recommended action and a second account identifier associated with the recommended action. The method can include the one or more processors validating, by one or more processors, that the recommended action corresponds to at least one of the compatible actions and the second account identifier corresponds to the first account identifier. The method can include the one or more processors executing, by one or more processors, the recommended action for the first account identifier in response to the validation of the recommended action and the second account identifier.

In some aspects, the method can further include constructing, by one or more processors, a vector using the action. The method can further include the one or more processors constructing, by one or more processors, a plurality of vectors using the prompt. The method can further include comparing, by one or more processors, the vector constructed using the action with the plurality of vectors constructed using the prompt. The method can further include the one or more processors determining, by one or more processors, based on the comparison, the list of compatible actions corresponding to the action.

In some aspects, the method can further include obtaining, by one or more processors, from the model, an intent of the prompt. The method can further include the one or more processors selecting, by one or more processors, based on the intent, an index from a plurality of indexes. The method can further include the one or more processors and providing, by one or more processors, the index to the model to cause the model to generate a response that includes the index instead of the intent.

In some aspects, the method can further include obtaining, by one or more processors, from the model, a response to the prompt that indicates the recommended action, the second account identifier associated with the recommended action and the index.

In some aspects, the method can further include identifying, by one or more processors, a network security parameter of the client system. The method can further include the one or more processors comparing, by one or more processors, the network security parameter with the first account identifier and the action. The method can further include the one or more processors determining, by one or more processors, based on the comparison, the action is authorized.

In some aspects, the method can further include identifying, by one or more processors, from the model, one or more data points associated with the recommended action. The method can further include the one or more processors validating, by one or more processors, that the one or more data points corresponds to the recommended action. The method can further include the one or more processors and executing, by one or more processors, using at least one of the one or more data points, the recommended action for the first account identifier in response to the validation of the recommended action and the second account identifier.

In some aspects, the method can further include providing, to the model trained with machine learning, the prompt including the content and one or more historical responses to prompts. The method can further include the one or more processors obtaining, by one or more processors, from the model trained with machine learning, a response to the prompt that indicates a recommended action, and the second account identifier associated with the recommended action.

In some aspects, the method can further include providing, by one or more processors, to the model trained with machine learning, the prompt including the content and one or more historical responses to prompts. The method can further include the one or more processors obtaining, by one or more processors, from the model, a response to the prompt that indicates a recommended action and a second account identifier associated with the recommended action.

An aspect of the technical solutions is directed to a non-transitory computer-readable medium comprising instructions. The instructions, when executed by one or more processors coupled with memory, can cause the one or more processors to identify a request to execute an action associated with a first account identifier of a client system. The instructions, when executed by one or more processors coupled with memory, can cause the one or more processors to select a prompt that corresponds to the action, the prompt structured as text including one or more predetermined fields and one or more dynamic fields, the prompt identifying a list of compatible actions corresponding to at least one of the client system or the first account identifier. The instructions, when executed by one or more processors coupled with memory, can cause the one or more processors to embed content of the first account identifier into one or more of the dynamic field of the prompt, the content including at least a portion of the text or a least a portion of a metadata. The instructions, when executed by one or more processors coupled with memory, can cause the one or more processors to provide, to a model trained with machine learning, the prompt including the content. The instructions, when executed by one or more processors coupled with memory, can cause the one or more processors to obtain, from the model, a response to the prompt that indicates a recommended action and second account identifier associated with the recommended action. The instructions, when executed by one or more processors coupled with memory, can cause the one or more processors to validate that the recommended action corresponds to at least one of the compatible actions and the second account identifier corresponds to the first account identifier. The instructions, when executed by one or more processors coupled with memory, can cause the one or more processors to execute the recommended action for the first account identifier in response to the validation of the recommended action and the second account identifier.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 illustrates an example system of computing action search using natural language processing, according to some embodiments.

FIG. 2 illustrates an example system of computing action search using natural language processing, according to some embodiments.

FIG. 3 illustrates an example user interface with first query input, according to some embodiments.

FIG. 4 illustrates an example user interface with first action output, according to some embodiments.

FIG. 5 illustrates an example user interface with second query input, according to some embodiments.

FIG. 6 illustrates an example user interface with second action output, according to some embodiments.

FIG. 7 illustrates an example method of performing a computing action search using natural language processing, according to some embodiments.

FIG. 8 illustrates an example method of performing a computing action search using natural language processing, according to some embodiments.

FIG. 9 illustrates an example method of performing a computing action search using natural language processing, according to some embodiments.

FIG. 10 illustrates a flowchart diagram illustrating an example method of performing a computing action search using natural language processing, according to some embodiments.

FIG. 11 illustrates a block diagram of a computing system for implementing the embodiments of the technical solutions, in accordance with embodiments.

### DETAILED DESCRIPTION

Aspects of technical solutions are described herein with reference to the figures, which are illustrative examples of the technical solutions. The figures and examples below are not meant to limit the scope of the technical solutions to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, the technical solutions and the present implementations encompass present and future known equivalents to the known components referred to herein by way of description, illustration, or example.

The technical solutions described herein provide a system that accepts natural language queries to search within application systems. These systems assist users in navigating extensive systems or databases to find actions for implementing human resource tasks. In some cases, the systems can accept any query containing any action. However, this can lead to queries containing unsupported or incompatible actions being inputted, causing the system to crash or fail to provide the correct resources. This issue can be particularly challenging in environments where users frequently input actions into a system and rely on quick and accurate access to implement human resource tasks, such as in human capital management systems.

To overcome this and other technical challenges, the technical solutions described herein can utilize vector searches and models trained with machine learning to determine an intent of a search query. The intent of the search query can correspond to an action performed on an account identifier as identified by a model trained with machine learning. Additionally, the technical solutions can include matching an action identified by the service provider system in the search with an action that corresponds to the action compatible with the service provider system. The service provider system can utilize a machine learning engine to generate vector representations using the terms of the search query and compare the vector representations of the search query terms with the vector representations of the compatible actions of the service provider system to generate a list of compatible actions that correspond to the identified action in the search query term. The service provider system can then utilize the machine learning engine to determine which compatible action from the list of compatible actions most closely corresponds to the action identified in the search query terms. By using the machine learning engine, the service provider system can provide an improved query or prompt in a search bar that corresponds to the intent of the search query that used natural language. In doing so, the technical solutions provide more accurate and contextually relevant content regardless of the action in the search query or if natural language was used in the search query, thereby maintaining a search query that corresponds with the intent of the original received search query while improving the overall user experience and efficiency in accessing information.

In an illustrative example, the service provider system can receive a query that corresponds to an action in the form of a natural language prompt. For example, the machine learning engine identifies an intent of the query, and shows unique results based on a query associated with the intent. After receiving a selection of a result, the service provider system can generate a virtual tile below a search bar where the virtual tile contains information entered in the query. For example, the service provider system can receive a query to view the organization information of a specific account identifier. The service provider system can then use a machine learning engine (e.g., a generative artificial intelligence service) to point out which, if any, action compatible with the service provider system is the query trying to invoke, and metadata related to that service provider system action from the query. The service provider system then loads the virtual tile with the action and account identifier to provide a query that corresponds to the provided query and is compatible with the service provider system. Thus, the technical solutions achieve technical improvements including reducing the number of queries received and reducing time and effort of executing various workflows-thus improving user interface operation, user experience and conserving computer resources.

In an example of a technical solution described herein, the system can include or utilize a model trained with machine learning to determine and return the intent of a query or request received. These models assist the system in determining the right compatible action to choose by determining the intent of the query or request. In some cases, the models can return the full description of the intent of the query or request. However, this can lead to the model outputting a lot of text when many queries or requests are received by the system, causing the model to suffer performance issues, lag and not output within an expected time period. This issue can be particularly challenging in environments where users frequently input actions into a system and rely on quick and accurate access to implement human resource tasks, such as in human capital management systems.

To overcome this and other technical challenges, the technical solutions described herein can utilize indexes that can correspond to full descriptions of the intent, can be stored in system memory, and provided by the model, the system, users of the system or users of the client system. This allows the model to output an index that points to a description of an intent instead of providing a description of an intent, thereby providing a more efficient model and system that minimizes technical problems associated with excessive output of models trained with machine learning, conserve processing and networking resources, and improve the system's overall reliability and performance.

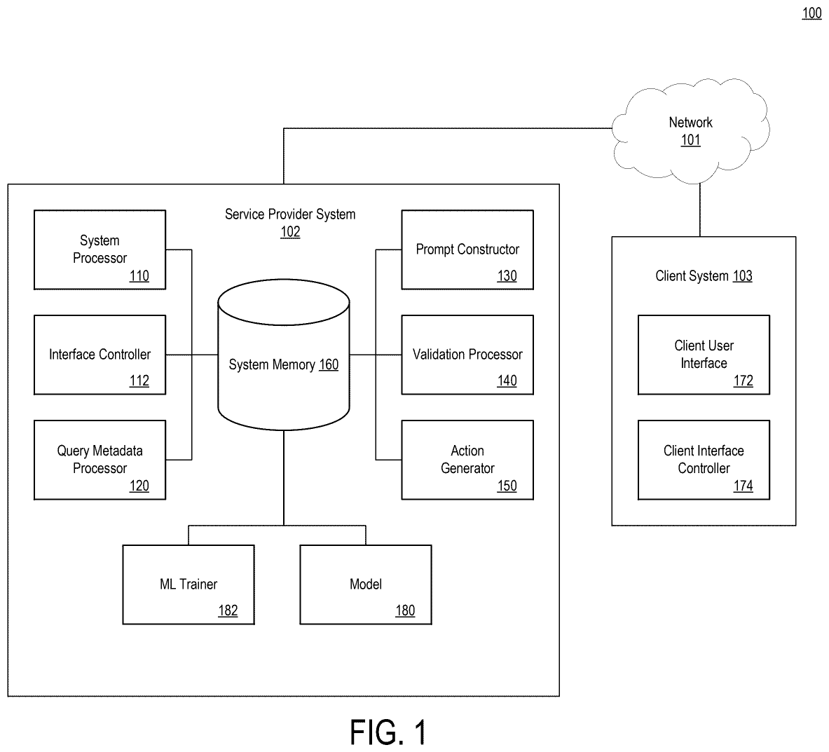

FIG. 1 depicts an example system for computing action search using natural language processing, according to one or more aspects. As illustrated by way of example in FIG. 1, a system 100 can include a service provider system 102. The service provider system 102 can interface with or otherwise communicate with a client system 103 via a network 101. The service provider system 102 can include or otherwise utilize a system processor 110 to identify a request to execute an action. The service provider system 102 can include, utilize or operate a query metadata processor 120 to select a prompt that corresponds to the action. In some example, the request can include the prompt. The service provider system 102 can include or operate a prompt constructor 130 to embed content of a first account identifier into one or more of the fields of the prompt. The service provider system 102 can utilize, operate, or include the system processor 110 to provide, to a model 180 trained with machine learning, the prompt including the content. The service provider system 102 can utilize, operate, or include the action generator 150 to obtain, from the model 180, a response to the prompt that indicates a recommended action, and a second account identifier associated with the recommended action. The validation processor 140 can validate that the recommended action corresponds to at least one of the compatible actions and the second account identifier corresponds to the first account identifier. The system processor 110 can execute the recommended action for the account identifier.

The service provider system 102 can include or execute on a physical computer system operatively coupled or coupleable with one or more components of the system 100. The service provider system 102 can include a virtual computing system, an operating system, and a communication bus to effect communication and processing. The service provider system 102 can include one or more of a system processor 110, an interface controller 112, a query metadata processor 120, a prompt constructor 130, a validation processor 140, an action generator 150, a system memory 160, or a combination thereof. For example, one or more of the system processor 110, the interface controller 112, the query processor 120, the prompt constructor 130, the validation processor 140, the action generator 150, the system memory 160, or a combination thereof can be at least partially integrated with the system processor 110 or the system memory 160. The service provider system 102 can be distributed on one or more computer systems, or instances of computing systems. The service provider system's 102 components can be located or distributed on different computing systems or instances of computing systems.

The system processor 110 can execute one or more instructions associated with the service provider system 102. The system processor 110 can include an electronic processor, an integrated circuit, or the like including one or more of digital logic, analog logic, digital sensors, analog sensors, communication buses, volatile memory, nonvolatile memory, and the like. The system processor 110 can include, but is not limited to, at least one microcontroller unit (MCU), microprocessor unit (MPU), central processing unit (CPU), graphics processing unit (GPU), physics processing unit (PPU), embedded controller (EC), or the like. The system processor 110 can include a memory operable to store or storing one or more instructions for operating components of the system processor 110 and operating components operably coupled to the system processor 110. For example, the one or more instructions can include one or more of firmware, software, hardware, operating systems, embedded operating systems. The system processor 110 or the service provider system 102 generally can include one or more communication bus controller to effect communication between the system processor 110 and the other elements of the service provider system 102.

The interface controller 112 can facilitate the service provider system 102 to communicate via the networks 101. For example, the service provider system 102 can communicate with the client system 103, The interface controller can include one or more communication interfaces. A communication interface can include, for example, an application programming interface (“API”) compatible with a particular component of the service provider system 102, the client system 103, or any other component. The communication interface can use a particular communication protocol compatible with a particular component of the service provider system 102. The communication interface may use the same or a different communication protocol when communicating with a particular component of the client system 103. The interface controller 112 can be compatible with particular content objects and can be compatible with particular content delivery systems corresponding to particular content objects, structures of data, types of data, or a combination thereof. For example, the interface controller 112 can be compatible with transmission of text data or binary data structured according to one or more metrics or data of the client system 103.

The system memory 160 can store data associated with the system 100, the service provider system 102, or a combination thereof. The system memory 160 can be a computer-readable memory that can store or maintain any of the information described herein. The system memory 160 can maintain one or more data structures, which may contain, index, or otherwise store each of the values, pluralities, sets, variables, vectors, numbers, or thresholds described herein. The system memory 160 can be accessed using one or more memory addresses, index values, or identifiers of any item, structure, or region maintained in the system memory 160. The system memory 160 can be accessed by the components of the service provider system 102, or any other computing device described herein, via the network 101. In some implementations, the system memory 160 can be internal to the service provider system 102. In some implementations, the system memory 160 can exist external to the service provider system 102 and may be accessed via the network 101. For example, the system memory 160 may be distributed across many different computer systems (e.g., a cloud computing system) or storage elements and may be accessed via the network 101 or a suitable computer bus interface.

The client system 103 can include a computing system associated with a database system. For example, the client system 103 can correspond to a cloud system, a server, a distributed remote system, or a combination thereof. For example, the client system 103 can include an operating system to execute a virtual environment. The operating system can include hardware control instructions and program execution instructions. The operating system can include a high-level operating system, a server operating system, an embedded operating system, or a boot loader. The client system 103 can include a client user interface 172, or a client interface controller 174. The client system 103 can be associated with an organization such as a business entity (e.g., a sole proprietorship, a corporation, a limited liability corporation, etc.). The client system can be distributed across different computing systems or instances of computing systems.

The client user interface 172 can include one or more devices to receive input from a user or to provide output to a user. For example, the client user interface 172 can correspond to a display device to provide visual output to a user and one or more or user input devices to receive input from a user. For example, the input devices can include a keyboard, a mouse, a touch-sensitive panel of the display device, or any other such input device or a combination thereof. The display device can display at least one or more presentations as discussed herein, and can include an electronic display. An electronic display can include, for example, a liquid crystal display (LCD), a light-emitting diode (LED) display, an organic light-emitting diode (OLED) display, or the like. The display device can receive, for example, capacitive or resistive touch input. The display device can be housed at least partially within the client system 103.

The client interface controller 174 can facilitate the service provider system 102 with one or more of the network 101 and the client system 103, by one or more communication interfaces. The client interface controller 174 can include one or more communication interfaces. A communication interface can include, for example, an application programming interface (“API”) compatible with a particular component of the service provider system 102, the client system 103, or any other component. The communication interface can use a particular communication protocol compatible with a particular component of the client system 103. The communication interface may use the same or a different communication protocol when communicating with a particular component of the service provider system 102. The client interface controller 174 can be compatible with particular content objects and can be compatible with particular content delivery systems corresponding to particular content objects, structures of data, types of data, or a combination thereof. For example, the client interface controller 174 can be compatible with transmission of text data or binary data structured according to one or more metrics or data of the service provider system.

The model 180 can include any number of machine learning model such as generative artificial intelligence models, which can include Machine learning systems configured to detect intent of requests and prompts by learning patterns and structures from existing data.

Model 180 can include any machine learning models trained to obtain an intent of a prompt or indicate that an action corresponds with one or more actions that are compatible with a service provider system. Model 180 can be a neural network, a natural language processing model, a feature extraction algorithm, or a combination thereof. Model 180 can be configured or trained by Machine learning (ML) trainers 182 to obtain an intent of a prompt or indicate that an action corresponds with one or more actions that are compatible with a service provider system.

The model 180 can include any combination of hardware and software for obtaining the intent from input. The input can include natural language inputs. The model 180 can include one or more of: neural networks, decision-making models, linear regression models, natural language models, random forests, classification models, generative artificial intelligence models, reinforcement learning models, clustering models, neighbor models, decision trees, probabilistic models, classifier models, any other type and form of models, or a combination thereof. The model 180, can include, for example, models include natural language processing (e.g., support vector machine (SVM), Bag of Words, Counter Vector, Word2Vec, k-nearest neighbors (KNN) classification, long short erm memory (LSTM)), RNN based long short term memory (LSTM), Hidden Markov Models, You Only Look Once (YOLO), LayoutLM) (classification ad clustering models (e.g., random forest, XGBBoost, k-means clustering, DBScan, isolation forests, segmented regression, sum of subsets 0/1 Knapsack, Backtracking, Time series, transferable contextual bandit) or other models such as named entity recognition, term frequency-inverse document frequency (TF-IDF), stochastic gradient descent, Naïve Bayes Classifier, cosine similarity, multi-layer perceptron, sentence transformer, data parser, conditional random field model, Bidirectional Encoder Representations from Transformers (BERT), among others.

The model 180 can include generative artificial intelligence models, also referred to as generative artificial intelligence models 180, which can include any machine learning systems configured to create new content, such as text, images, or audio, by learning patterns from the data stored in a storage or a database (e.g., training datasets). The generative artificial intelligence models 180 can be trained using techniques, such as supervised learning, unsupervised learning, and reinforcement learning. Generative artificial intelligence models 180 can utilize data set from the stored data to create logical inferences between various complex structures in the data set to generate coherent outputs for prompts input into the models 180.

The model 180 implemented as generative artificial intelligence models can include any machine learning or artificial intelligence model designed to generate content or new content, such as text, images, or code, by learning patterns and structures from existing data. Such models 180 (e.g., a generative artificial intelligence models) can include any model, a computational system or an algorithm that can learn patterns from data (e.g., chunks of data from various input images, videos, documents, computer code, templates, forms, etc.) and make predictions or perform tasks without being explicitly programmed to perform such tasks. The generative artificial intelligence model 180 can include, utilize or refer to a large language model. The generative artificial intelligence model 180 can be trained using a dataset of documents (e.g., text, images, videos, audio or other data). The generative artificial intelligence model 180 can be designed to understand and extract relevant information from the dataset. The generative artificial intelligence model 180 can leverage natural language processing techniques and pattern recognition to comprehend the context and intent of a prompt (e.g., one or more instructions), which can be used as input into the model 180 to trigger the desired output or result.

The model 180, including for example a generative artificial intelligence model, can be designed, constructed, utilize or include a transformer architecture with one or more of a self-attention mechanism (e.g., allowing the model to weigh the importance of different words or tokens in a sentence when encoding a word at a particular position), positional encoding, encoder and decoder (multiple layers containing multi-head self-attention mechanisms and feedforward neural networks). For example, each layer in the encoder and decoder can include a fully connected feed-forward network, applied independently to each position. The service provider system 102 can apply layer normalization to the output of the attention and feed-forward sub-layers to stabilize and improve the speed with which the generative artificial intelligence model 180 is trained. The service provider system 102 can leverage any residual connections to facilitate preserving gradients during backpropagation, thereby aiding in the training of the deep networks. Transformer architecture can include, for example, a generative pre-trained transformer, a bidirectional encoder representations from transformers, transformer-XL (e.g., using recurrence to capture longer-term dependencies beyond a fixed-length context window), text-to-text transfer transformer,

ML trainers 182 can include any software or algorithms used to train machine learning models. ML trainers 182 can be a training algorithm, a data preprocessing function, or a model optimization technique. ML trainers 182 can be used to configure or train model 180 to obtain an intent of a prompt, obtain a response to the prompt that indicates a recommended action, and second account identifier associated with the recommended action or indicate that an action corresponds with one or more actions that are compatible with a service provider system. For example, ML trainers 182 can use training data to optimize the performance of models 180. ML trainers 182 can help ensure that the machine learning models generate accurate and contextually relevant vector representations.

ML trainers 182 can include any combination of hardware and software for training models 180. ML trainers 182 can use datasets including documents, texts, multimedia or character strings to generate embedding vectors, summaries of assistance content documents, generate JSON data structures comprising such summaries and comparing different keyword and semantic search results to identify and filter out any duplicate results, or any other such datasets. Through training, the model 180, also referred to as a generative artificial intelligence model 180, can learn or adjust its understanding of mapping embeddings to particular issues to implement any features of the system processor 110, metadata processor 120, prompt constructor 130, validation processor 140 or action generator 150. The internal parameters can include numerical values of a generative artificial intelligence model 180 that the model learns and adjusts during training to optimize its performance and make more accurate predictions. Such training and can include iteratively presenting the various data chunks or documents of the dataset (e.g., embeddings) to the generative artificial intelligence model 180, comparing its predictions with the known correct answers, and updating the model's parameters to minimize the prediction errors. By learning from the embeddings of the dataset data chunks, the generative artificial intelligence model 180 can gain the ability to generalize its knowledge and make accurate predictions or provide relevant insights when presented with prompts.

The ML trainer 182 can train the model 180 with machine learning with data from the service provider system 102. For example, the model 180 can be trained using Supervised Learning, Unsupervised Learning, Reinforcement Learning, Transfer Learning, Semi-Supervised Learning, Self-Supervised Learning, Active Learning, or a combination thereof. The data used to train the model 180 can include data from the client system 103, the system memory 160, one or more data points of a human capital management system actions. third party data, or data received via the network 101.

The system processor 110 can identify a request to execute an action associated with a first account identifier of a client system 103. For example, the request can include prompts, or the action. The request can be phrased using natural language. The request can be provided by the client system 103. The action can include phrases such as “promote”, “fire” “find”, “match”, or “include”. The action can correspond to one or more human resources activities supported by the service provider system 102. The action can be or include a network operation. The network operation can be or include an action. The request can include a data structure such as linked lists, stacks, heap, queues, or a combination thereof. The request can include the identity of the individual or system that sent the request, a network security role, an organization role. The organization role can include the organization role of the individual or system that sent the role or the organization role of the first account identifier. For example, the first account identifier can include an employee number, a first name, a last name, a string of characters, an employee identifier, a date, or a combination thereof. The first account identifier can be associated with an employee, a user, the client system 103, an organization or organizational unit of the organization, or any combination thereof, but is not limited thereto. The first account identifier can correspond to a profile data structure of an individual of an organization associated with the client system 103. In another example, the system processor 110 can identify the request via the network 101. The system processor can receive the request to execute the action associated with the first account identifier of the client system 103 via one or more networks 101. The system processor 110 can identify the request to execute an action when the system processor 110 or the interface controller 112 receives the request to execute an action.

The system processor 110 can construct a vector using the action. For example, the system processor 110 can construct the vector using the text of the action. For example, the system processor 110 can construct the vector by converting the text of the action into a numerical representation of the action using an embedding model. The system processor 110 can use embedding models such as Word2Vec, GloVe, FastText, BERT, Sentence-BERT, Universal Sentence Encoder, ResNet, Inception, VGG, CLIP, DALL-E, any other embedding model, or a combination thereof to convert the text of the action into a numerical representation of the action. The system processor 110 can place the numerical representation of the text of the action into one or more vectors. For example, the vector can include a semantic vector used for a vector semantic search. The vector can include word embeddings, sentence embeddings, document embeddings, or contextual embeddings. The vector can be or include a numerical representation of the prompt or the action. For example, the vector can include a numerical representation of the action. The system processor110 can utilize, include, operate or be the model 180 to construct the vector using the action. In another example, the system processor can construct a plurality of vectors using the prompt. The model 180 can construct or generate, using an embedding model, the vector using the prompt. The model 180 can include embedding models such as Word2Vec, GloVe, FastText, BERT, Sentence-BERT, Universal Sentence Encoder, ResNet, Inception, VGG, CLIP, DALL-E, any other embedding model, or a combination thereof. The system processor 110 can construct one or more vectors using the text of the list of compatible actions of the prompt. In some implementations, the system processor 110 can convert the text of the list of compatible actions of the prompt into one or more numerical representations of the text of the list of compatible actions of the prompt using embeddings models or the model 180. The system processor 110 can place one or more numerical representations of the text of the list of compatible actions of the prompt into one or more vectors.

The system processor 110 can compare the vector constructed using the action with the one or more vectors constructed using the prompt. The comparison can be part of a semantic search operation to identify the action corresponding to the prompt. In some implementations, the comparison can be or include cosine similarity, distance similarity, Manhattan distance, Jaccard similarity, any such similarity, or a combination thereof. The similarity can be stored as a score. The comparison can return one or more outputs, where the outputs can represent a predetermined number, or a number specified by a configuration setting of compatible actions that correspond to the action. The one or more outputs can represent results with a relevance score. The relevance score can include a number from zero to one hundred, zero to one, a percentage, a grade, or any scoring technique. In some examples, a higher relevance score can indicate a greater correspondence, similarity or match between the action and the action found in the database as compared to a lower relevance score. In some examples, the relevance score can indicate a greater correspondence between the action and the action found in the database when the relevance score is lower relative to higher relevance scores. The system memory 160, or other storage can store the index. In some examples, the database can contain actions or a list of actions compatible with the service provider system 102. In some examples, actions that are compatible with the service provider system 102 can include actions that are compatible with a human capital management system. In some examples, the system processor 110 can create an index to store the vectors constructed using the prompt.

The system processor 110 can determine, based on the comparison, that the list of compatible actions corresponds to the action. The comparison can be part of a semantic search operation to identify the action corresponding to the prompt. In some implementations, the comparison can be or include cosine similarity, distance similarity, Manhattan distance, Jaccard similarity, any such similarity, or a combination thereof. The similarity can be stored as a score. In another example, the system processor 110 can determine the list of compatible actions corresponds to the action based on the comparison by assigning the vector representing the text of the action and the one or more of the vectors representing the text of the list of compatible actions of the prompt a relevance score in response to the comparison. In some examples, the system processor 110 can use scoring methods for vector semantic searches to score of the one or more vectors representing the text of the list of compatible actions of the prompt. Some implementations of the scoring method can include Term Frequency-Inverse Document Frequency, “Best Match 25”, Precision@K, AP@K, MAP@K, Mean Average Precision, Normalized Discounted Cumulative Gain, any other such scoring method or a combination thereof. In some examples, the relevance score can include a number from zero to one hundred, or any such scoring system. In some examples, the relevance score can indicate a greater correspondence between the action and the compatible action when the relevance score is closer to a maximum relevance is closer to a maximum relevance score relative to other relevance scores of outputs. In some examples, the relevance score can indicate a greater correspondence between the action and the action found in the database when the relevance score is closer to a minimum relevance score relative to other relevance scores of output. In some examples, the system processor 110 can determine one or more of the compatible actions correspond to the action by comparing the relevance score of the one or more vectors representing the text of the list of compatible actions of the prompt with the vector representing the text of the action. In some examples, the system processor 110 can use the model 180 to score the one or more vectors representing the text of the list of compatible actions of the prompt. For example, the system processor 110 can input the one or more outputs into the model 180 to generate a relevance score. In some examples, the model 180 can assign each output of the one or more of outputs a relevance score using one or more of the scoring methods. In some examples, the list of compatible actions can include actions that are supported by system service provider 102. The list of compatible actions can include promoting, terminating, hiring, searching, updating, approving payroll, adjusting salary, compensation, activity log, teams, delegated approval, career profile, additional information, documents, accommodations, issuing bonus, approving timesheets, request time off, schedule shifts, conduct performance review, assign training, set goals, enroll in benefits, update benefits, review benefits usage, viewing organization information or a combination thereof.

The system processor 110 can determine the prompt corresponds to the action based on the output of the search. For example, the system processor 110 can determine the prompt corresponds to the action by comparing the relevance score of each vector of the one or more of vectors representing the text of the list of compatible actions of the prompt. For example, the system processor 110 can determine a plurality of compatible actions corresponds to the action based on the comparison when a predetermined number or a number specified by a configuration setting of the vectors representing the text of the list of compatible actions of the prompt exceed a threshold relevance score. In this example, the vectors representing the text of the list of compatible actions of the prompt with the highest relevance score relative to the relevance score of each vector of the one or more of vectors representing the text of the list of compatible actions of the prompt that exceeds a threshold score (e.g., above 60, 75, 95 or 99) can represent or be the prompt that corresponds to the action. In another example, the system processor 110 can determine that the one or more compatible actions corresponds to the action when the comparison contains vectors from the vector semantic search that include a predetermined number or a number specified by a configuration setting of the vectors representing the text of the list of compatible actions of the prompt from the index with the highest relevance score.

The system processor 110 can identify a network security parameter of the client system 103. For example, the network security parameter can indicate what action a user or client system 103 can perform. The network security parameter can correspond to or represent the position or the authorization level of the user, or the client system 103. The network security parameter can indicate which account identifier or individual the user can perform actions on. The user can include a user of the client system 103, or a user of the system provider system 102. The network security parameter can indicate restrictions of compatible actions. The network security parameter can be encrypted. The network security parameter can include encrypted messages, requests, data packets. or a combination thereof.

The system processor 110 can compare the network security parameter with a first account identifier and the action. For example, the network security parameter can indicate the user's position, and the actions the user can perform on the first account identifier to cause the system processor 110 to compare the network security parameter with the first account identifier and the action. For example, when the first account identifier includes “Bob Smith, accountant” and the network security parameter indicates the user's employment role as accounting manager, the system processor 110 can compare, using the information in the network security parameter, the user's employment role and the first accountant identifier. In some examples, the system processor 110 can determine, based on the comparison, the action is authorized. For example, the system processor 110 can determine the action is authorized by using the information contained in the network security parameter to determine that the user has a position or authorization level to perform the action on the first account identifier.

The system processor 110 can identify a request to execute an action query including text and metadata, the request indicative of a request to execute an action associated with a requested individual, the metadata indicative of the requested individual. For example, the system processor 110 can obtain text, where the text can include natural language prompts, actions, or integers. In some examples, the text can include words such as “promote”, “find”, “match”, “include”, a human resources related action or a combination thereof. In some examples, the system processor 110 can obtain the text from the client system 103 via the network 101. For example, the system processor 110 can obtain metadata, where the metadata can include information regarding the client system 103, the client user interface 172, or the client interface controller 174. For example, the metadata can include names, employee identifiers, employee numbers, or a number. In some examples, the metadata can include or be a string. In some examples, the string can include a sequence of characters to represent text.

The system processor 110 can identify, using the model 180, one or more data points associated with the action. In one example, the system processor 110 can identify the one or more data points using the model 180 with machine learning. In some examples, the system processor 110 can use a predefined list of actions and one or more data points associated with the actions to identify the one or more data points associated with the action. In some examples, the one or more data points can include an amount of currency, an amount of time, a benefit provider, a date, a time block, a goal, salaries, the first account identifier, payroll period, approver identification, salary details, bonus type, timesheet submission date, shift date, training course details, goal description, type of page, type of benefit, type of leave, or a combination thereof. In some examples, the system processor 110 can identify the one or more data points using the model 180 with machine learning.

The query metadata processor 120 can select a prompt that corresponds to the action, the prompt structured as text including one or more fields, the prompt identifying a list of compatible actions corresponding to at least one of the client system 102 or the first account identifier. For example, the query metadata processor 120 can select a prompt that corresponds to the action by using the model 180 to compare the action with the list of compatible actions identified by the prompt. In some examples, the query metadata processor can input the action and one or more prompts into one or more models 180 trained to validate that one or more prompts corresponds to the action. In response to inputting the action, and at least one of the prompts into the model 180, the model 180 can determine beyond a threshold of confidence (e.g., above 75%, 95% or 99% certainty) that at least one or more of the prompts corresponds to the action. For example, the fields can include actions. In some examples, the actions can include promoting, terminating, hiring, searching, updating, approving payroll, adjusting salary, issuing bonus, approving timesheets, request time off, schedule shifts, conduct performance review, assign training, set goals, enroll in benefits, update benefits, review benefits usage, viewing organization information or a combination thereof. The fields can include names of employees, the first account identifier, the second account identifier, an employee identifier, or a combination thereof.

The query metadata processor 120 can select the prompt that corresponds to the action based on the output of the search, the prompt structured as text comprising one or more fields, the prompt identifying a list of compatible actions corresponding to at least one of the client system or the first account identifier. For example, the query metadata processor 120 can select the prompt that contains one or more compatible actions that exceed the threshold relevance score. The prompt can include the five outputs of the search with the highest relevance score. In some examples, the query metadata processor can select the prompt that corresponds to the action based on the determination, the prompt structured as text comprising one or more fields, the prompt identifying a list of compatible actions corresponding to at least one of the client system 103, an account identifier (e.g., the first account identifier), or the requested individual. The query metadata processor 120 can select the prompt that corresponds to the action based on the determination, where the determination includes five compatible actions from the prompt with relevance scores that exceed a threshold score. For example, the threshold score can include a score of seventy-five, eighty-five or ninety. The threshold score can include a dynamically calculated threshold score where a predetermined number of scores can exceed the threshold score. In another example, the query metadata processor 120 can select, by the service provider system 102, a prompt that corresponds to the action, the prompt structured as text including one or more static fields and one or more dynamic fields, the prompt identifying a list of compatible actions corresponding to at least one of the client system or requested individual.

The prompt constructor 130 can embed the content of the first account identifier into one or more of the fields of the prompt, the content including at least a portion of the text or at least a portion of a metadata associated with the prompt. For example, the system processor 110 can embed the content of the first account identifier into one or more fields of the prompt by directly inputting text or using rich text editors within the dynamic input. The content of the first account identifier can include the requested individual's name, employee number, birthdate, or social security number. In another example, the prompt constructor 130 can embed, by the service provider system 102, content of the requested individual into one or more of the dynamic inputs of the prompt, the content including at least a portion of the text or at least a portion of the metadata. For example, the system processor 110 can embed the content of the requested individual into one or more of the dynamic inputs of the prompt by directly inputting text or using rich text editors within the dynamic input. In another example, the content of the requested individual can include the requested individual's name, employee number, birthdate, social security number, or a combination thereof. In an example, the prompt constructor 130 can obtain a query and metadata from the system processor 110 or the query metadata processor 120 and generate a prompt.

The system processor 110 can provide, to a model 180 trained with machine learning, the prompt including the content. For example, the model 180 can be, include, or utilize a machine learning model. In some examples, the machine learning model can include or be a generative artificial intelligence model. The model 180 can extract the action from the prompt and determine which compatible action the action corresponds to. For example, the system processor 110 can format the prompt into a suitable format for input into the model 180. In this example, the system processor 110 can format the prompt into Hierarchical Data Format (HDF5), comma-separated values (CSV), TFRecord, NumPy (NPY), Parquet, JavaScript Object Notation (JSON), extensible markup language (XML), or a combination thereof. The prompt can include data structures such as arrays, linked lists, stacks, queues, or a combination thereof. For example, the model 180 can determine the intent of the prompt by analyzing the prompt using a machine learning model. In another example, the system processor 110 can provide, by the service provider system 102 to a model 180, the prompt including the content.

The system processor 110 can provide, to a model 180 trained with machine learning, the prompt including the content and one or more historical responses to prompts. For example, the system processor 110 can input historical responses to prompts to the model 180 from the system memory 160. In some examples, the historical responses to prompts can include one or more previous responses to prompts that have been received by the system processor 110, one or more data sets of responses to prompts in the system memory 160, or one or more historical samples of responses to prompts. In some examples, the historical responses to the prompts can be retrieved via the network 101.

The action generator 150 can obtain, from the model 180, a response to the prompt that indicates a recommended action and second account identifier associated with the recommended action. For example, the action generator 150 can utilize, operate, include, provide or execute one or more models 180. Model 180 can include any combination of machine learning algorithms and techniques for identifying the intent of a prompt. The model 180 can be used to detect intent from natural language. For example, if the model 180 receives a prompt from a user or a request that includes a string of characters such as “Promote Bob”, the model 180 will be able to analyze the prompt, extract the intent that the user wants to promote an employee, look for employees named “Bob” that the user is able to promote and return a response indicative of a recommended action and the second account identifier. In this example, the second account identifier can include the name “Bob”. In another example, the model 180 can receive a prompt from a user that states “Promote John D”, the model 180 will be able to analyze the prompt, extract the intent that the user wants to promote an employee, look for employees with a first name “John” and a last name that starts with “D” that the user has permission to promote and return a response indicative of a recommended action and the second account identifier. In this example, if more than one employee with the first name “John” with the last name “D” exists, the model 180 can search for an employee that has the first name “John” or a last name that starts with a “D” that the user interacts with the most based on historical queries or an analysis by the model 180 on user interactions. In another example, the model 180 can search for an employee based on user input, restricting its search to employees on whom the user has permission to perform the recommended actions. In some examples, the second account identifier can be a name of an employee associated with the client system 103, an employee identifier or a full name. In some examples, the recommended action can be or include the compatible action.

In some examples, the model 180 can provide the recommended action by comparing the action embedded in the prompt with the list of compatible actions to determine which compatible actions are most relevant to the action embedded in the prompt. The comparison can include a semantic search using vectors. In some examples, the vectors can represent the action or include numerical representations of the actions. In some examples, the second account identifier can be, correspond to, or include the first account identifier. In another example, the action generator 150 can obtain, by the service provider system 102 from the model 180, a response to the prompt including the content, the response indicative of a recommended action and an identified individual. In some examples, the action generator 150 can format the response to the prompt based on the client system 102. For example, the action generator 150 can format the response in a tile in order to display the response as a tile containing the response to the prompt on the client user interface 172.

In some examples, the action generation 150 can obtain, from the model 180, an intent of the prompt. For example, the model 180 can generate the intent of the prompt by analyzing the prompt with machine learning algorithms. For example, the intent can include the actions. In some examples, the intent can include promoting, firing, hiring, promoting, terminating, hiring, searching, updating, approving payroll, adjusting salary, issuing bonus, approving timesheets, request time off, schedule shifts, conduct performance review, assign training, set goals, enroll in benefits, update benefits, review benefits usage, or a combination thereof.

In some examples, the action generator 150 can select based on the intent, an index from a one or more of indexes. In some examples, the index can be linked with the intent. In some examples, the index can be unique or be assigned to the intents. In some examples, the user or client system 103 can assign the index to the intents. In some examples, the system processor 110 can assign the index to the intents. In some examples, the model 180 can assign the index to the intents. In some examples, the action generator 150 can create embeddings that represent each intent. In some examples, the embeddings can include numerical representations of words.

The action generator 150 can provide the index to the model to cause the model 180 to generate a response that includes the index instead of the intent. For example, the action generator 150 can update the model's 180 output mechanism so that model 180 returns the index of the intent instead of the full description of the intent. In an illustrative example, the prompt can include the phrase “what are my pending PTO requests?”. In this example, the system processor 110 can provide the previously mentioned prompt to the model 180 and the action generator 150 can obtain, from the model 180, an intent of the prompt. In some examples, the intent of the prompt can include “sor-query”, system of record query, additional description, a machine learning model generated description of the intent of the prompt, or a combination thereof. In some examples, the additional description can include “this intent has to do with paid time off requests that have been approved by an associate's manager”. In some examples, the additional description can be indexed in a table. In some examples, the action generator 150 can obtain, using the model 180, the index of the indent. In this example, the index can include a phrase such as “sor-PTO-associate-manager”. In some examples, the action generator 150 can select, based on the intent, an index from a plurality of indexes. In an example, the action generator 150 can use the model 180 to select, based on the intent, an index from a plurality of indexes. In this example, the intent can include one or more phrases such as “sor-query” or “this intent has to do with paid time off requests that have been approved by an associate's manager” In this example, the index can include one or more phrases such as “sor-PTO-associate-manager”. In an example, the action generator 150 can provide the index to the model 180 to cause the model to generate a response that includes the index instead of the intent. In this example, the intent can be relevant to the prompt. In some examples, the action generator 150 can train the model 180 to recognize and output the index based on the prompt. In some examples, the action generator 150 can store the indexes in the system memory 160 or the client system 103. In some examples, the action generator 150 can retrieve the full description of the intent using the index outputted from the model 180. In some examples, the action generator 150 can retrieve the full description of the intent using the index from the system memory 160 or the client system 103. In an example, the action generator 150 can obtain a response where the index causes the model 180 to stop outputting the full description of the intent or output the index instead of the full description of the intent.

The action generator 150 can obtain, from the model 180, a response to the prompt that indicates a recommended action, a second account identifier associated with the recommended action and an index. For example, the index can point to a location in the system memory 160 where a full description of the intent of the prompt is. In some examples, the action generator 150 can use the index to obtain the full description of the intent of the prompt and replace the index with the full description of the intent of the prompt.

The validation processor 140 can validate that the recommended action corresponds to at least one of the compatible actions and the second account identifier corresponds to the first account identifier. In another example, the validation processor 140 can validate, by the service provider system 102, that the recommended action corresponds to at least one of the compatible actions. For example, the validation processor 140 can validate the recommended action with the compatible actions by determining that the recommended actions are equivalent to at least one compatible action. For example, the validation processor 140 can validate the recommended action with the compatible actions by determining that the recommended actions perform the equivalent action of at least one compatible action of the service provider system 102. For example, the validation processor 140 can validate the recommended action with the compatible actions by using the model 180 trained with machine learning to determine that each of the recommended actions correspond with at least one compatible action and the second account identifier corresponds to the first account identifier. In some examples, the model 180 can use machine learning techniques such as semantic similarity, word embeddings, contextual embeddings, cosine similarity, clustering, synonym detection, or a combination thereof to analyze the comparison between the recommended action and compatible action. In this example, the model 180 can compare the recommended action with compatible action using at least one of the previously mentioned machine learning techniques and return a value indicating a correspondence level between the recommended action and the compatible action. In some examples, the value can satisfy a correspondence threshold or indicate that the recommended action corresponds to the compatible action when the value is above or equivalent to a threshold value. For example, the threshold value can be or include seventy-five hundredths, one, eighty hundredths, fifty hundredths, or sixty hundredths. In some examples, the recommended actions can include promoting, terminating, hiring, searching, updating, approving payroll, adjusting salary, issuing bonus, approving timesheets, request time off, schedule shifts, conduct performance review, assign training, set goals, enroll in benefits, update benefits, review benefits usage, or a combination thereof. In some examples, the compatible actions can include the recommended actions.

In another example, the validation processor 140 can input the recommended action, at least one of the compatible actions, the second account identifier and the first account identifier into one or more models 180 trained to validate that the recommended action corresponds to at least one of the compatible actions and the second account identifier corresponds to the first account identifier. In response to inputting the recommended action, at least one of the compatible actions, the second account identifier and the first account identifier into the model 180, the model 180 can determine beyond a threshold of confidence (e.g., above 75%, 95% or 99% certainty) that the recommended action corresponds to at least one of the compatible actions and the second account identifier corresponds to the first account identifier.

The validation processor 140 can utilize or operate the model 180 to validate second account identifier with the first account identifier. The model 180 can validate the second account identifier with the first account identifier by using one or more of the machine learning techniques described herein to compare the second account identifier with the first account identifier and return a value indicating a correspondence level. When the value satisfies a predetermined threshold level, the model 180 or validation processor 140 can indicate that the second account identifier corresponds with the first account identifier. In some examples, the second account identifier can include a first name, a last name, a middle name, a string of character, an employee identifier, a data of birth, or a combination thereof.

In an example, the validation processor 140 can validate that the one or more data points correspond to the action. For example, the validation processor 140 can utilize or operate the model 180 to validate that the one or more data points correspond to the action. In this example, the validation processor 140 can input the one or more data points and the action into one or more models 180 trained to validate that the one or more data points correspond to the action. In response to inputting the one or more data points and the action into the model 180, the model 180 can determine beyond a threshold of confidence (e.g., above 75%, 95% or 99% certainty) that the one or more data points correspond to the action.

In an example, the validation processor 140 can include or communicate with a model 180 such as a machine learning model (MLM), or the prompt constructor 130. For example, the prompt constructor 130 can include a classifier to classify the input query, and then select a template for a prompt that is matched to, tuned to, or configured for the corresponding classification. For example, the validation processor 140 can transmit a prompt from the prompt constructor 130 to the model 180 and can receive a response from the model 180 to be further validated as discussed herein.

The system processor 110 can execute the recommended action for the first account identifier in response to the validation of the recommended action and the second account identifier. For example, the system processor 110 can execute the recommended action for the first account identifier to generate a virtual tile configured to be displayed by the client interface controller 174, where the virtual tile includes the recommended action or the second account identifier. In this example, the interface controller 112 can send the virtual tile via the network to the client system 103. In some examples, the client interface controller 174 can display the virtual tile. For example, the system processor 110 can execute the recommended action for the first account identifier to generate a network packet containing recommended action, the second account identifier, or the one or more data points associated with the recommended action. In another example, the system processor 110 can execute, by the service provider system 102, the recommended action for the requested individual, in response to the validation of the recommended action and the validation of the requested individual. In another example, the system processor 110 can execute, using at least one of the data points, recommended action for the first account identifier in response to the validation of the recommended action and the second account identifier. For example, the system processor 110 can execute the recommended action using at least one of the data points for the first account identifier to generate a virtual tile configured to be displayed by the client interface controller 174 or the client system 103. In this example, the interface controller 112 can send the virtual tile via the network 101 to the client system 103. In another example, the action generator 150 can perform or execute any action associated with the service provider system 102. For example, the action generator 150 can perform one or more of a predetermined number of human resource actions.

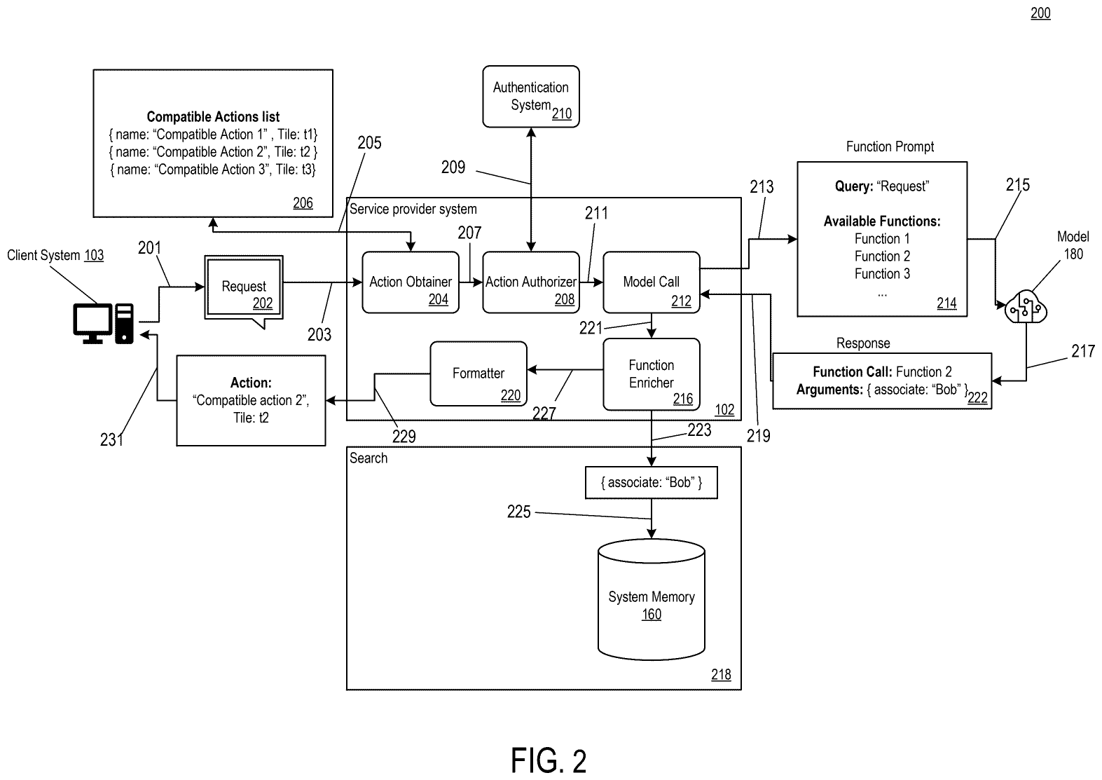

FIG. 2 depicts an example system for computing action search using natural language processing, according to one or more aspects. As illustrated by way of example in FIG. 2, a system 200 can be integrated with at least one of the components of the system 100, the service provider system 102, or the client system 103. Example system 200 can include one or more requests 202, one or more client systems 103 (e.g., of FIG. 1), one or more action obtainer 204, one or more actions 206, one or more Action Authorizer 208, one or more authentication system 210, one or more model call 212, one or more function prompt 214, one or more model 180 (e.g., of FIG. 1 among others), one or more function enrichers 216, one or more search 218, one or more formatters 220, or one or more responses 222.

The request 202 can include a data structure such as linked lists, stacks, heap, or queues. The request 202 can include the identity of the individual or system that sent the request 202, a network security role, an organization role. The request 202 can include a request to execute an action associated with a first account identifier of a client system 103. The action can correspond to the compatible actions list 206. The organization role can include the organization role of the individual or system that sent the role or the organization role of the first account identifier. The action obtainer 204 can include any combination of hardware and software for processing requests in order to select a compatible action based on the action in the request. The action authorizer 208 can include any combination of hardware and software for authorizing actions using the authentication system 210. For example, the action authorizer 208 can receive the compatible action from the action obtainer 104. In an example, the action authorizer 208 can send the user of the client system 103 and the compatible action to the authentication system 210 in order to verify that user is authorized to perform the action. The authorization system 210 can include any combination of hardware and software to authorize actions. The authorization system 210 can authorize actions based on the client system 103, the user sending the request using the client system 103, or the action obtained from the action obtainer 204.

The model call 212 can include any combination of hardware and software to format the action, and a first account identifier for the format prompt 214. The function prompt 214 can include any combination of hardware and software to input a prompt to the model 180. The response 222 can include any combination of hardware and software to obtain a response from the model 180. The response 222 can include a function call and an argument. The function enricher 216 can include any combination of hardware and software to enrich the response 222 For example, the function enricher can search for the first account identifier named in the response 222. The formatter 220 can include any combination of hardware and software for formatting the response 222 for the client system 103 (e.g., the client user interface 172 of FIG. 1 among others).

At operation 201, the client system 103 can generate a request 202. At operation 203, the service provider system 102 can identify the request 202. At operation 205, the action obtainer can obtain a compatible action from the compatible actions list 206 that corresponds to the action contained in the request 202. At operation 207, the action obtainer can send the compatible action to the action authorizer 208. At operation 209, the action authorizer 208 can authorize the compatible action received by sending the compatible action, the first account identifier, or a client system identifier to the authentication system 210. At operation 209, the authentication system 210 can authorize the compatible action by referencing an authorization list that indicates which account identifier can execute or request which compatible action. At operation 209, the authorization system 210 can send back an authorization indicator where the authorization indicator contains an indication of the authorization of the compatible action based on the reference of the authorization list. In an example, the authorization indicator can include a “1” or a “0” where the “1” can indicate the compatible action is authorized and the “0” can indicate that the compatible action is not authorized. The authorization indicator can include instructions or an indicator that can configure the action authorizer 208 to send the client system 103 an authorization error message and not allow the action authorizer 208 to send the compatible action to the model call 212.

At operation 211, the action authorizer 208 can send the compatible action and the first account identifier to the model call 212. At operation 213, the model call can send the compatible action and the first account identifier to the function prompt 214. At operation 215, the function prompt 214 can format the compatible action and the first account identifier into a suitable format for input into the model 180. For example, the function prompt 214 can format the compatible action and the first account identifier into formats such as Hierarchical Data Format (HDF5), comma-separated values (CSV), TFRecord, NumPy (NPY), Parquet, JavaScript Object Notation (JSON), or extensible markup language (XML). At operation 217, the response 222 can obtain a recommended action and a second account identifier. At operation 219, the model call 212 can receive the response 222. For example, the response 222 can includes a function call where the function call includes the recommended action that corresponds to one or more of the compatible actions lists, and arguments where the argument can include a second account identifier that can corresponds to the first account identifier.

At operation 221, the model call 212 can provide the response 222 to the function enricher 216. At operation 223, the function enricher can provide the second account identifier to the search 218. In an example, the function enricher can provide the second account identifier to the search 218 in order to validate that the second account identifier corresponds to the first account identifier. At operation 225, the search 218 can search the system memory 160 for an account identifier that corresponds to the second account identifier or the first account identifier. In an example, the search 218 can search using a semantic search. In another example, the search 218 can validate that the second account identifier corresponds to the first account identifier by searching the client system 103 or the system memory 160 for the first account identifier. The search 218 can use the account identifier of the request sender to check that the second account identifier or first account identifier is managed by the account identifier of the request sender. The system memory 160 can include system of record data for an organization that the client system 103 belongs to. The search 218 can search a system of record to retrieve additional data points that correspond to the second account identifier. For example, the search 218 can search a system of record located in a human capital management system for an employee named “Bob S.” and retrieve additional data points related to “Bob S.” such as “Bob S.”'s full name, date of birth, contact details, employee Identification number, job title, department, hire date, employment status, salary, bonuses, benefits information, performance records, training and development, attendance records, leave balances, leave history, name of direct supervisor, team members, organizational hierarchy, coworkers, office location, work location, remote work status, documentation related to compliance, documentation related to legal agreements, or documentation related to audits.

At operation 227, the function enricher 216 can add the additional data points to response 222. At operation 229 the formatter 220 can format the response 222 for display in the client system 103 (e.g., the client user interface 172). For example, the formatter 220 can convert the response to format suitable for display on a computer screen, mobile device, television or electronic display. At operation 231, the formatter 220 can convert the response containing the action into a tile for display on the client system 103 (e.g., the client user interface 172).

This technical solution can be directed to one or more of use cases in addition to the use cases and examples discussed herein. For example, a user can be directed to a persona. The person can correspond to manager self-service, in this case, employee self-service, or practitioner self-service, but is not limited thereto. This technical solution can be directed to one or more domains in addition to the domains and examples discussed herein. Domains can include human resources (HR), payroll, time, talent, benefits, or a combination thereof. According to example usage metrics, a page workflow for promoting an associate is requested three hundred twenty times over thirty days. An expected behavior can include that when one or more user clicks on the provider system action shown in Search results, the provider system provides the relevant page with pre-filled parameters, including an employee name and job change type. For example, various parameters can configure this provider system action, including an Utterance: Promote [associate], a Fulfillment Tile/Page ID: 08f23e25eace4e3594a9074c75ec9c00, a Tile Parameter for an Associate ID, a Tile Parameter for MovementType (‘Promote’ in this example), or any combination thereof. Depending on the use case, additional data can be included for configuration.

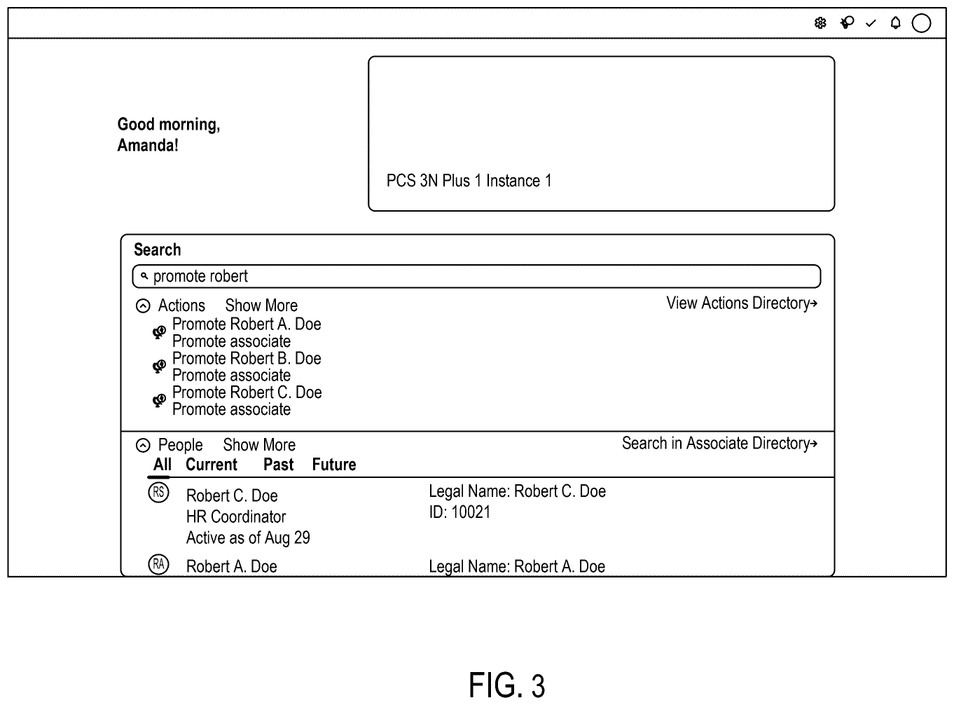

FIG. 3 depicts an example user interface with first query input, according to some embodiments. As illustrated by way of example in FIG. 3, a user interface with first query input 300 can include at least a user interface for a use case to promote an employee. In some examples, managers can take at least 3 page loads and multiple clicks to be able to get to the tile that allows them to promote an associate. In this example and others, this can potentially take 1-3 minutes of time depending on familiarity with an application. In some examples, by having a service provider system action for this workflow, managers will be able to type an intention as natural language in search and be taken to the tile with a single click. In some examples, this can help reduce the time and effort of managers from few minutes down to a few seconds and can result in significant reduction in computation cost and energy expended by reducing or eliminating redundant network transmission, page loads, and rendering events.

The user interface with first query input 300 can include a welcome message, a search bar, virtual tiles below the search bar, and a directory of account identifiers. In an example, the welcome message can include messages such as “Good morning”. In another example, the search bar can be utilized by the service provider system 102 (e.g., of FIG. 1 among others). In some examples, the search bar can include a request to execute an action associated with a first account identifier of a client system. In some examples, the virtual tiles can include the first action output. In some examples, the first action output can be or include the recommended action for the first account identifier. In some examples, the directory of account identifiers can include names, roles, employee IDs and start dates of employees associated with an organization.

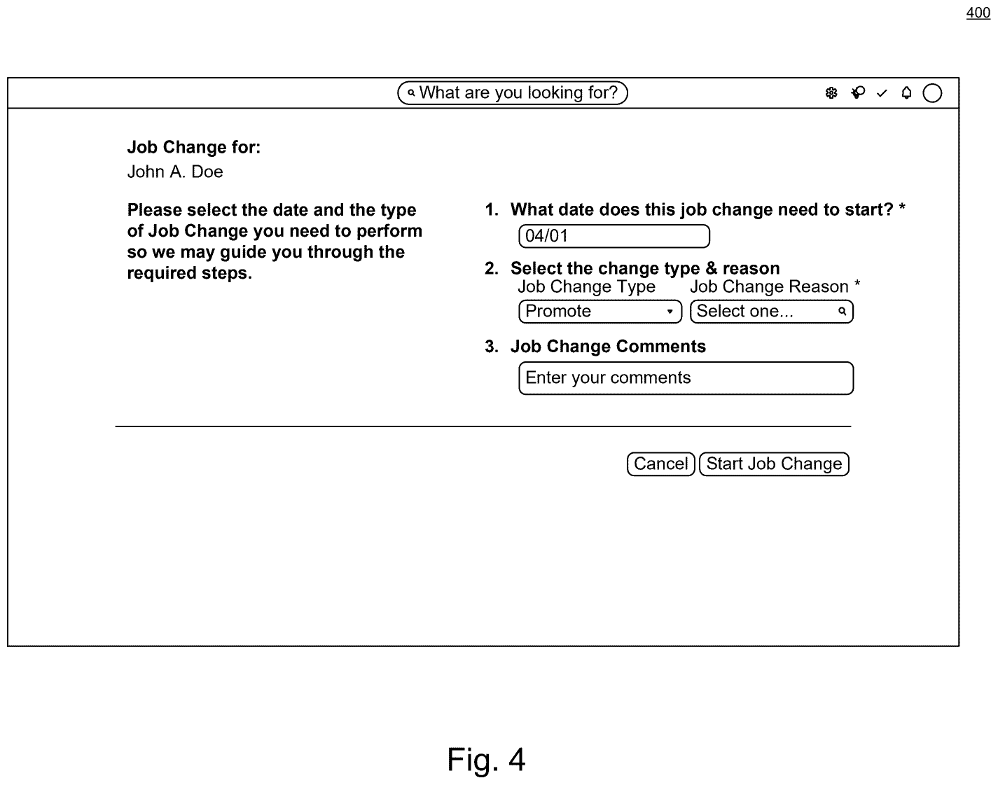

FIG. 4 depicts an example user interface with first action output, according to some embodiments. As illustrated by way of example in FIG. 4, a user interface with first action output 400 can include at least a user interface for a use case to promote an employee.

In an example, the user interface with first action output 400 can include prompts that related to the first query input, or questions. The example user interface can display prompts such as “Select the change type & reason”, or “Job Change Comments” with areas under the prompt configured to accept input. The example user interface can display questions. The questions can include “What date does this job change need to start?”.

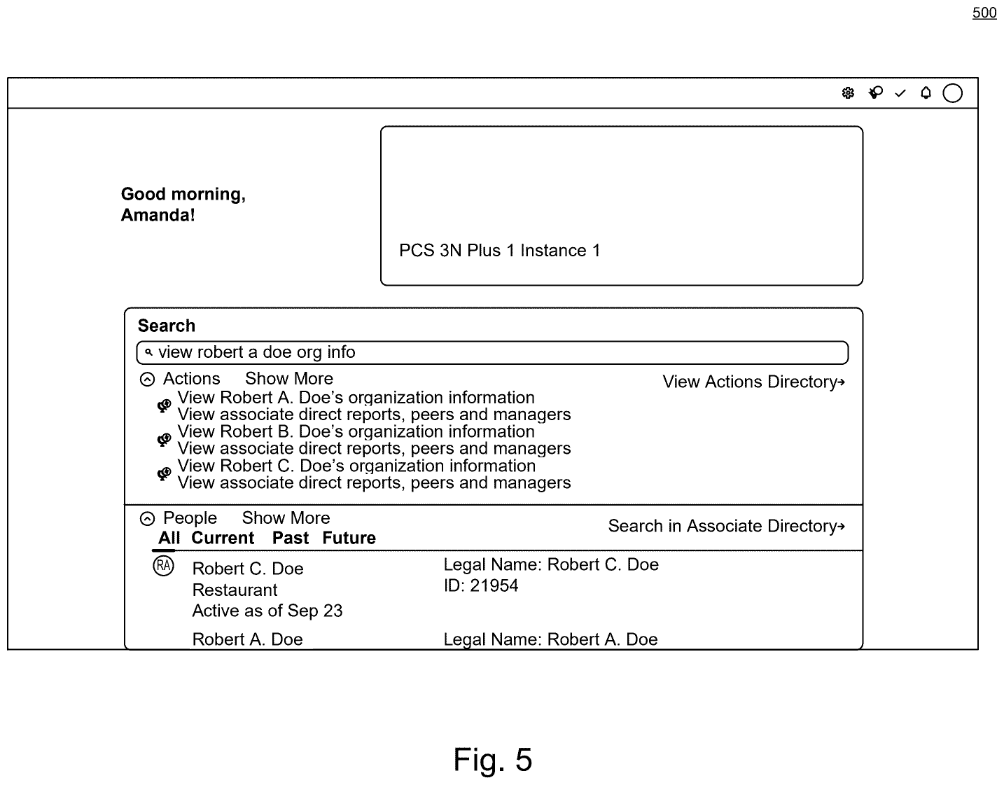

FIG. 5 depicts an example user interface with second query input, according to some embodiments. As illustrated by way of example in FIG. 5, a user interface with second query input 500 can include at least a user interface for a use case to identify employee data.

In an example, the user interface with second query input 500 can include a search bar configured to accept natural language queries or requests, or virtual tiles. In this example, the service provider system 102 (e.g., of FIG. 1 among others) can return virtual tiles below the search bar where the virtual tiles contains an action compatible with the service provider system 102 and account identifiers that are in the service provider system 102 where the action correspond to an action and account identifier identified by the service provider system in the natural language queries or requests.

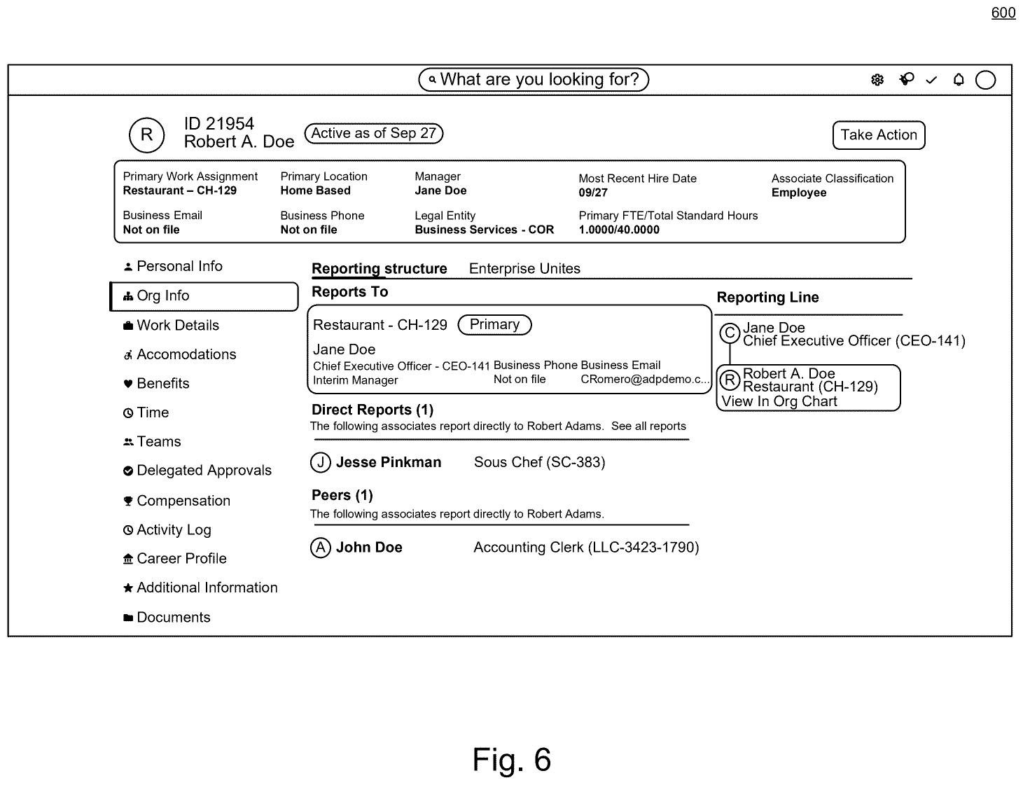

FIG. 6 depicts an example user interface with second action output, according to some embodiments. As illustrated by way of example in FIG. 6, a user interface with second action output 600 can include at least a user interface for a use case to identify employee data.

In an example, the user interface with second query input 600 can include one or more labels that corresponds to various facets of employee data. These labels can include a primary work assignment of an employee, a primary location of an employee, a manager of an employee, a most recent hire date of an employee, an associate classification of an employee, a business email of an employee, a business phone of an employee, a legal entity that the employee belongs to, a primary full time equivalent ratio of an employee, a total standard hours that an employee is working. The user interface with second query 600 can include selectable buttons that correspond to pages that contain various facets of employee data. The selectable buttons can include buttons that lead to pages that includes personal information, organization information, work details, accommodations, benefits, time, teams, delegated approvals, compensation, activity log, career profile, additional information, documents.

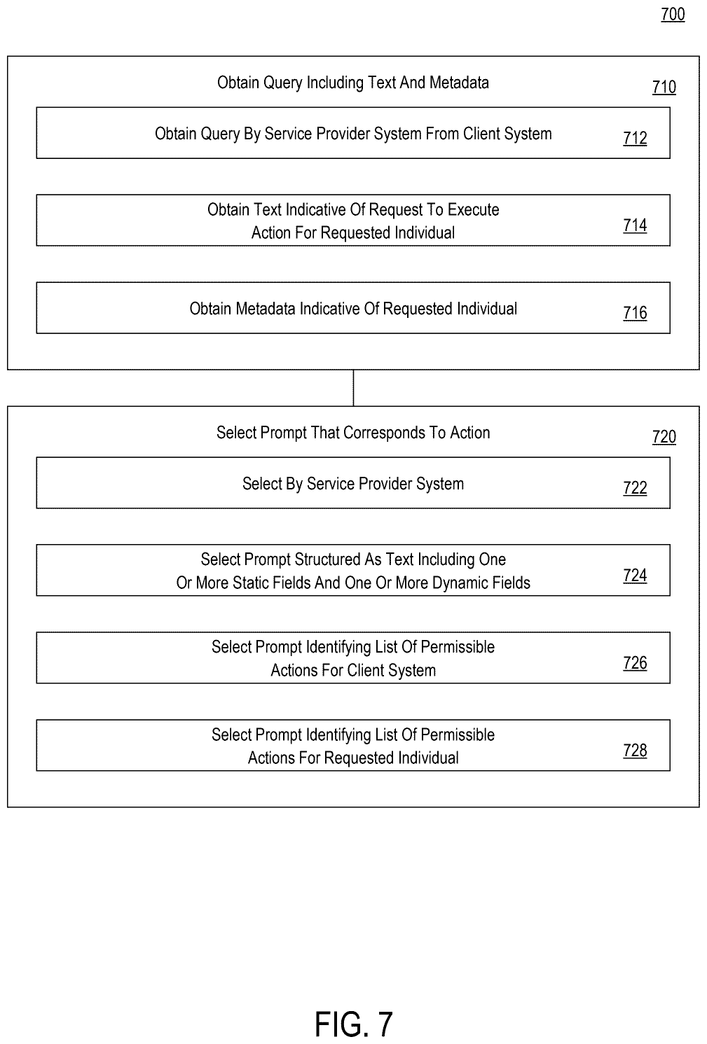

FIG. 7 depicts an example method of performing smart search actions, according to some embodiments. At least one of the system 100, the service provider system 102, the client system 103, or any combination thereof, or any component thereof, can perform method 700.

At 710, the method 700 can obtain a query including text and metadata. At 712, the method 700 can obtain the query by a service provider system from a client system. At 714, the method 700 can obtain the text indicative of a request to execute an action for a requested individual. At 716, the method 700 can obtain the metadata indicative of the requested individual. In an aspect, the requested individual corresponds to a profile data structure of an individual of an organization associated with the client system. In an aspect, the action corresponds to a human resources activity, and the permissible actions correspond to human resource activities supported by the service provider system.

At 720, the method 700 can select a prompt that corresponds to the action. At 722, the method 700 can select by the service provider system. At 724, the method 700 can select the prompt structured as text including one or more static fields and one or more dynamic fields. At 726, the method 700 can select the prompt identifying a list of permissible actions for the client system. At 728, the method 700 can select the prompt identifying a list of permissible actions for the requested individual.

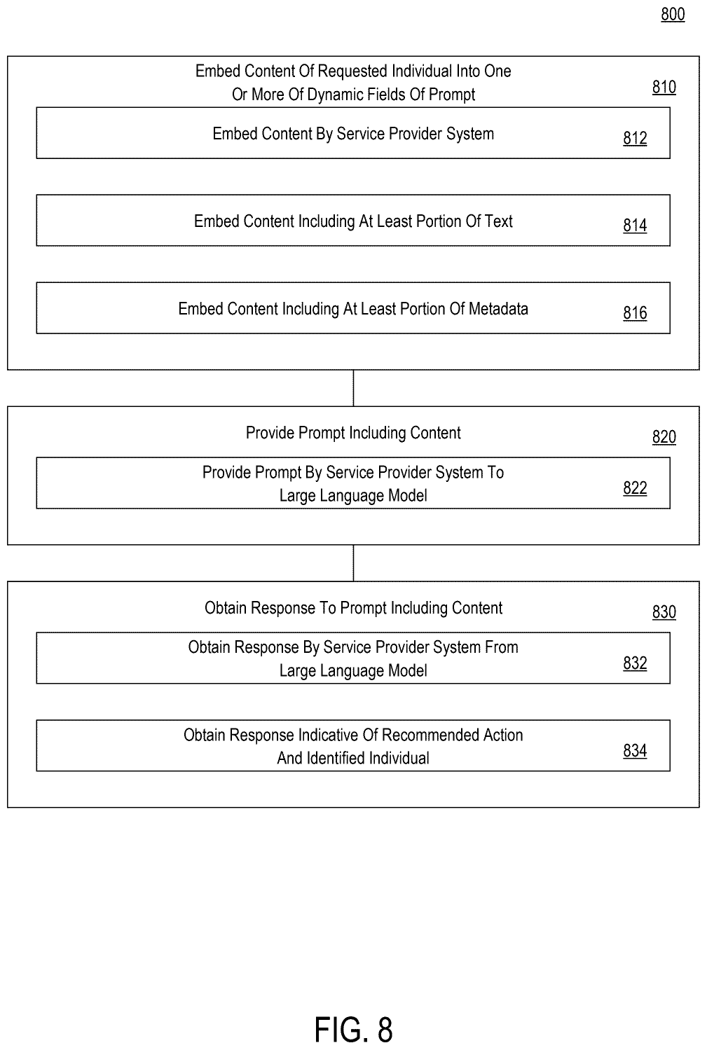

FIG. 8 depicts an example method of performing smart search actions, according to some embodiments. At least one of the system 100, the service provider system 102, the client system 103, or any combination thereof, or any component thereof, can perform method 800.

At 810, the method 800 can embed content of the requested individual into one or more of the dynamic fields of the prompt. At 812, the method 800 can embed the content by the service provider system. At 814, the method 800 can embed the content including at least a portion of the text. At 816, the method 800 can embed the content including at least a portion of the metadata.

At 820, the method 800 can provide the prompt including the content. At 822, the method 800 can provide the prompt by the service provider system to a large language model.

At 830, the method 800 can obtain a response to the prompt including the content. At 832, the method 800 can obtain the response by the service provider system from the large language model. At 834, the method 800 can obtain the response indicative of a recommended action and an identified individual.

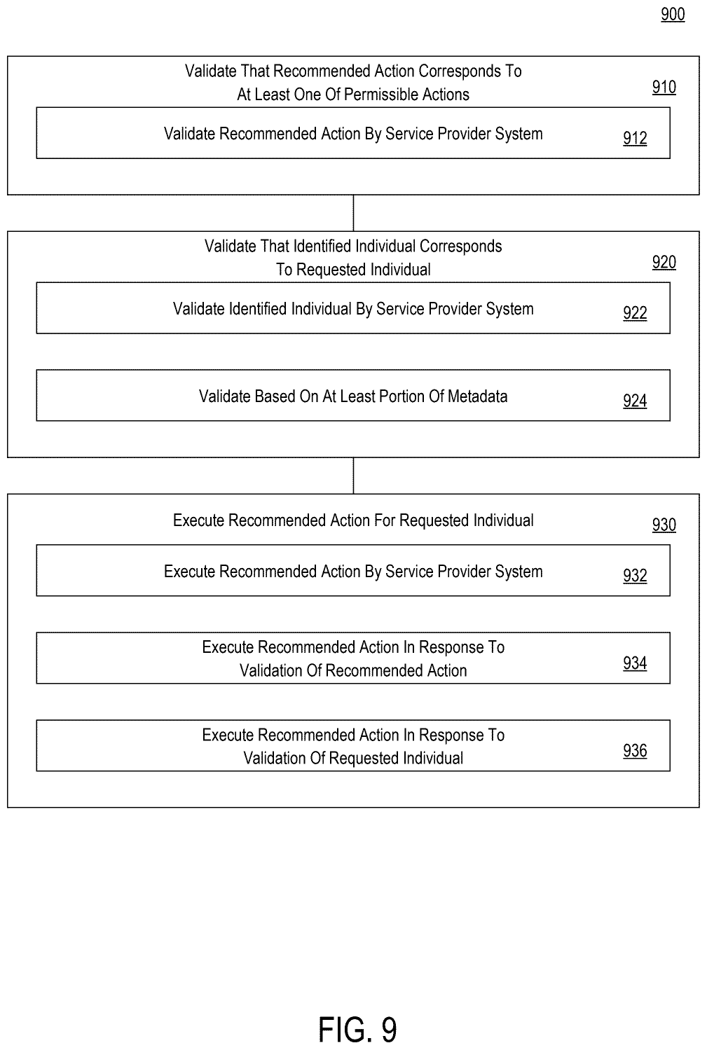

FIG. 9 depicts an example method of performing smart search actions, according to some embodiments. At least one of the system 100, the service provider system 102, the client system 103, or any combination thereof, or any component thereof, can perform method 900.

At 910, the method 900 can validate that the recommended action corresponds to at least one of the permissible actions. At 912, the method 900 can validate the recommended action by the service provider system.

At 920, the method 900 can validate that the identified individual corresponds to the requested individual. At 922, the method 900 can validate the identified individual by the service provider system. At 924, the method 900 can validate based on at least a portion of the metadata.

At 930, the method 900 can execute the recommended action for the requested individual. At 932, the method 900 can execute the recommended action by the service provider system. At 934, the method 900 can execute the recommended action in response to the validation of the recommended action. At 936, the method 900 can execute the recommended action in response to the validation of the requested individual.

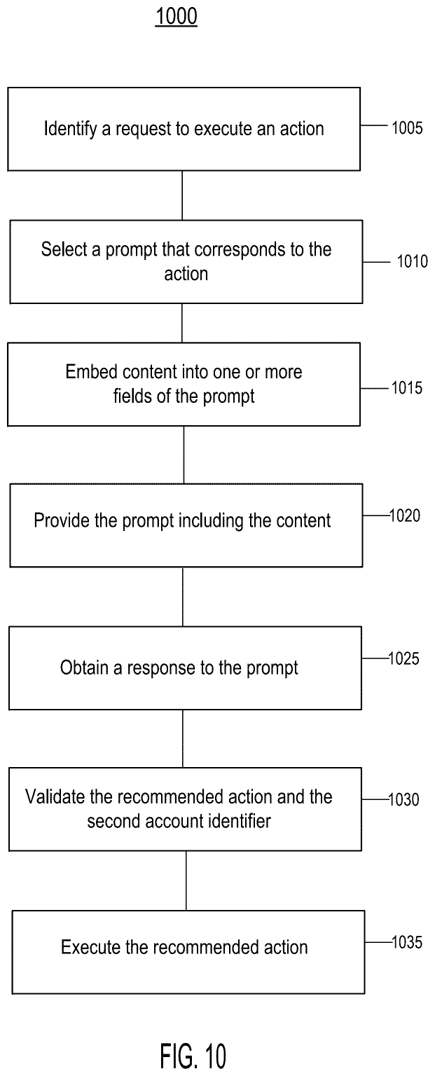

FIG. 10 illustrates a flow diagram of a method 1000 for performing smart search actions, according to some embodiments. At least one of the system 100, the service provider system 102, the client system 103, or any combination thereof, or any component thereof, can perform method 1000. The method 1000 can be performed by one or more systems or components depicted in FIG. 1, including, for example, a service provider system 102 of FIG. 1 implemented using processors 1110 configured to perform the functionalities of the service provider system 102 based on instructions, computer code or data stored on memory or storage (e.g., 1115, 1105 or 1125) of a computing system 1100. At a high level, method 1000 can include acts 1005-1035. At 1005, the method can identify a request to execute an action. At 1010, the method can select a prompt that corresponds to the action. At 1015, the method can embed content into one or more fields of the prompt. At 1020, the method can provide the prompt. At 1025, the method can obtain a response to the prompt. At 1030, the method can validate the recommended action and the second account identifier. At 1035, the method can execute the recommended action. In an aspect, the first account identifier can correspond to a profile data structure of an individual of an organization associated with the client system. In an aspect, the action can correspond to a human resources activity, and the permissible actions correspond to human resource activities supported by the service provider system.

At 1005, the method can identify a request to execute an action. The method can include one or more processors coupled with memory identifying a request to execute an action associated with a first account identifier of a client system. The one or more processors can identify a request to execute an action associated with a first account identifier of a client system. For example, a client user interface of a client device communicatively coupled with a service system provider can receive, via a search window of the client user interface, one or more requests, such as words, phrases or strings of characters of a request query. The request query can be or include any request query requesting an action, operation, document, process of a computing system. The computing system can include a human capital management system provided via a network of an enterprise operating a service provider system in communication with the human capital management system. For instance, the system processor of the service provider system can utilize the interface controller to identify one or more requests to execute an action associated with a first account identifier of a client system. The system processor of the service provider system can receive one or more requests to execute the action associated with the first account identifier of client system via one or more networks.

The method can include the system processor constructing a vector using the action. The vector can include a semantic vector, or a feature vector. The system processor can convert the prompt and action into numerical vectors. The numerical vectors can capture or include the prompt and actions semantic meaning. The vector can include vector embeddings. The vector embeddings can include embeddings of the prompt and action. The method can include the system processor constructing one or more vectors using the prompt. The system processor can construct the one or more vectors using the list of compatible actions contained in the prompt. The system processor can construct the one or more vectors using the list of compatible actions contained in the prompt by embedding the each of the compatible actions into a vector using an embedding model. Embedding models can include various types such as Word2Vec, GloVe, FastText, BERT, Sentence-BERT, Universal Sentence Encoder, ResNet, Inception, VGG, CLIP, DALL-E, or a combination thereof.

The method can include the system processor comparing the vector constructed using the action with the plurality of vectors constructed using the prompt. For example, the system processor can compare the vector constructed using the action with the plurality of vectors constructed using the prompt by ingesting the plurality of vectors constructed using prompt into an index and conducting a semantic search using the vector constructed using the action of the index. The search can output a relevance score for each vector of the plurality of vectors constructed using the prompt by comparing the embedding value of vector constructed using the action and each vector of the plurality of vectors constructed using the prompt.

The method can include the system processor determining a plurality of compatible actions corresponds to the action based on the comparison. The system processor can determine a plurality of compatible actions corresponds to the action by determining which vectors constructed using the prompt exceed a threshold relevance score.

The method can include the system processor executing a search, using the vector, of a database. The search can include a vector semantic search, a contextual search, an intent-based search, a vector search, a semantic mapping, an entity-based search, or a natural language processing (NLP) search. The search can include a search to find similar items based on mathematical similarity measures. The mathematical similarity measures can include cosine similarity, Jaccard similarity, Pearson correlation, Euclidean distance, Manhattan distance, or Minkowski distance. The search can find actions in the database that correspond to the action in the vector.

The method can include the system processor identifying a network security parameter of the client system. For example, the system processor can identify the network security parameter by identifying the position of the sender of the request. The system processor can identify the network security parameter by identifying the client system sending the request. The method can include the system processor comparing the network security parameter with a first account identifier or the action. The system processor can compare the network security parameter with a first account identifier by comparing a table of positions in the network security parameter with the first account identifier's position. The system processor can compare the network security parameter with the action by comparing a table of positions that correspond to authorized actions with the action and the first account identifier.

The method can include the system processor identifying a request to execute an action query including text and metadata, the request indicative of a request to execute an action associated with a requested individual, the metadata indicative of the requested individual. For example, the system processor can obtain text, where the text can include natural language prompts, actions, or integers. The method can include the system processor identifying, using the model 180, the one or more data points associated with the action. For example, the system processor can identify the one or more data points by providing the model the action and the first account identifier. The model can identify the one or more data points by using a machine learning model trained on the one or more data points that correspond to actions and account identifiers to generate predicted one or more data points that correspond to the action and the first account identifier.

The method can include the ML trainer training the model with data from the client system. For example, the ML trainer can train the model by obtaining, collecting, or identifying data from the client system, system memory or third-party data sources. The ML trainer can then clean, normalize or format the data based on the model. The processed data is then partitioned into training, validation, and test sets. The ML trainer can select a machine learning algorithm for the model based on the action, and the training set is used to fit the model. The model is iteratively refined through hyperparameter tuning using the validation set.

At 1010, the method can include selecting a prompt that corresponds to the action. The method can include the one or more processors selecting a prompt that corresponds to the action, the prompt structured as text including one or more fields, the prompt identifying a list of compatible actions corresponding to at least one of the client system or the first account identifier. For example, the query metadata processor can select a prompt that corresponds to the action by comparing the list of compatible actions with the action and selecting the prompt containing one or more compatible actions that correspond to the action. The comparison can include a semantic search of an index using a vector containing an embedding of the action, where the index contains one or more vectors where each vector contains one or more embeddings of the compatible action. For example, the request can include a string of characters reciting “I want to promote Bob S” where the action to be executed can include “to promote”, and the query metadata processor can select, using a semantic search, the list of compatible actions indicated by the prompt that includes a string of characters. In this example, the string of character can include “promote”, “promotion”, “demote”, “elevate”, or a combination thereof.

The method can include selecting the prompt that corresponds to the action based on the search, the prompt structured as text comprising one or more fields, the prompt identifying a list of compatible actions corresponding to at least one of the client system or the first account identifier. The method can include selecting, by the service provider system, a prompt that corresponds to the action, the prompt structured as text including one or more static fields and one or more dynamic fields, the prompt identifying a list of compatible actions corresponding to at least one of the client system or requested individual.

At 1015, the method can embed content into one or more fields of the prompt. The method can include the one or more processors embedding content of the first account identifier into one or more of the fields of the prompt, the content including at least a portion of the text or at least a portion of a metadata. For example, a query metadata processor can embed content of the first account identifier into one or more fields of the prompt, the content including at least a portion of the text or a least a portion of a metadata. The query metadata processor can embed the content of the first account identifier into one or more fields of the prompt by identifying the first account identifier contained in the request and structuring the prompt to contain the action and the first account identifier. For example, the query metadata processor can embed or insert “Bob S” into the prompt containing “promote”.

The method can include the query metadata processor embedding, by the service provider system, content including at least a portion of the text or at least a portion of the metadata. The method can include the system processor embedding the content of the requested individual into one or more of the dynamic inputs of the prompt

At 1020, the method can include providing the prompt including the content. The method can include the one or more processors providing, to a model trained with machine learning, the prompt including the content. For example, the system processor can provide, to a model trained with machine learning, the prompt including the content. For example, the system processor can provide the prompt to the model by formatting the prompt to a format that can be accepted by the model as input. In an illustrative example, the prompt can be formatted into a string of characters that can be acceptable by a model where the model includes a machine learning model.

The method can include the system processor providing, to a model trained with machine learning, the prompt including the content and one or more historical responses to prompts. The system processor can store past responses to the prompts in the system memory. The system processor can provide the one or more historical responses to the prompts by retrieving the past responses to the prompts from the system memory, the client system, the network or a combination thereof. For example, the historical responses can include previous requests identified by the data provider system, previous responses selected by the system processor, a data set with responses or requests, or a combination thereof.

At 1025, the method can obtain a response to the prompt. The method can include the one or more processors obtaining, from the model, a response to the prompt that indicates a recommended action and a second account identifier associated with the recommended action. For example, the action generator can obtain, from the model 180 a response to the prompt that indicates a recommended action, and a second account identifier associated with the recommended action. The action generator can obtain a response from the model by prompting the model for the response. The method can include the action generator obtaining, by the service provider system from the model, a response to the prompt including the content, the response indicative of a recommended action and an identified individual. For example, the action generator can format the response to the prompt based on the client system.

The model can generate the response to the prompt that indicates a recommended action, and the second response identifier associated with the recommended action by conducting a semantic search using the action embedded in the prompt. The semantic search can include the model comparing the list of compatible actions with the action embedded in the content of the prompt. The model can generate a response to the prompt by comparing the action embedded in the content of the prompt with list of compatible actions identified by the prompt and select, using machine learning, the most relevant action from the list of compatible actions.

The method can include the action generator obtaining, from the model, an intent of the prompt. For example, the model can obtain the intent of the prompt by analyzing the action embedded in the prompt using machine learning. In this example, the action generator can provide the action to the model along with an inquiry. The inquiry can include a question regarding the intent of the action. The model can utilize generative artificial intelligence to provide the intent of the prompt.

The method can include the action generator selecting, based on the intent, an index from one or more indexes. The method can include the action generator providing the index to the model to cause the model to generate a response that includes the index instead of the intent. The method can include the action generator obtaining, from the model, a response to the prompt that indicates a recommended action, a second account identifier associated with the recommended action and the index.

At 1030 the method can validate the recommended action and the second account identifier. The method can include the one or more processors obtaining, from the model, a response to the prompt that indicates a recommended action and second account identifier associated with the recommended action. For example, the method can include the validation processor validating that the recommended action corresponds to at least one of the compatible actions, and the second account identifier corresponds to the first account identifier. For example, the validation processor can use the model to validate that that recommended action corresponds to at least one of the compatible actions and the second account identifier corresponds to the first account identifier.

The method can include the validation processor inputting the recommended action, at least one of the compatible actions, the second account identifier and the first account identifier into one or more models trained to validate that the recommended action corresponds to at least one of the compatible actions and the second account identifier corresponds to the first account identifier. The method can include the validation processor validating that the one or more data points correspond to the action.

At 1035, the method can execute the recommended action. The method can include the one or more processors executing the recommended action for the first account identifier in response to the validation of the recommended action and the second account identifier. For example, the system processor can execute the recommended action for the first account identifier in response to the validation of the recommended action and the second account identifier.

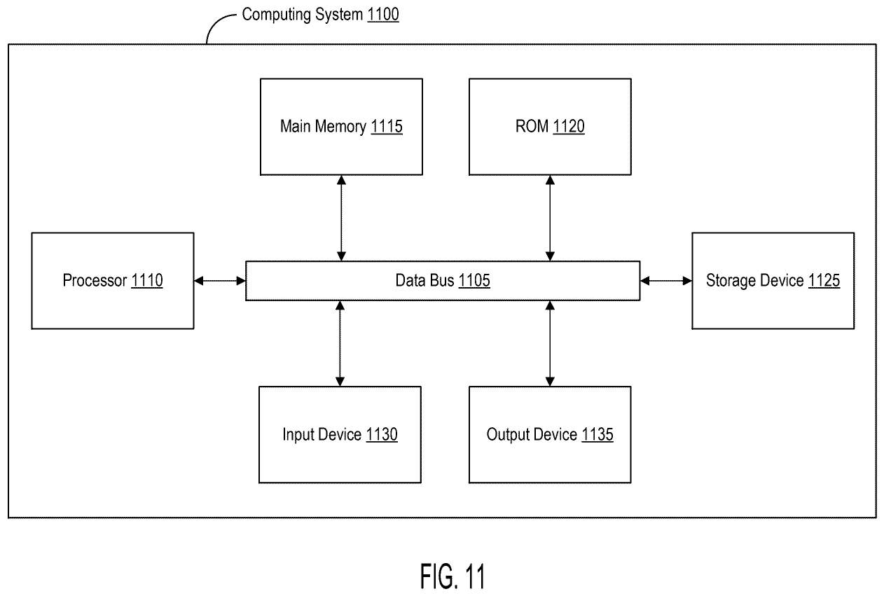

FIG. 11 illustrates a block diagram of a computing system 1100 for implementing the embodiments of the present solution, according to some embodiments. FIG. 11 illustrates a block diagram of an example computing system 1100, which can also be referred to as the computer system 1100. Computing system 1100 can be used to implement elements of the systems and methods described and illustrated herein, such as for example, commands, instructions or data described herein. Computing system 1100 can be included in, provide support for, or run any device (e.g., client system 103 or service provider system 102), or any other feature or component described herein.

Computing system 1100 can include at least one data bus 1105 or other communication device, structure or component for communicating information or data. Computing system 1100 can include at least one processor 1110 or processing circuit coupled to the data bus 1105 for executing instructions or processing data or information. Computing system 1100 can include one or more processors 1110 or processing circuits coupled to the data bus 1105 for exchanging or processing data or information along with other computing systems 1100. Computing system 1100 can include one or more main memories 1115, such as a random-access memory (RAM), dynamic RAM (DRAM), cache memory or other dynamic storage device, which can be coupled to the data bus 1105 for storing information, data and instructions to be executed by the processor(s) 1110. Main memory 1115 can be used for storing information (e.g., data, computer code, commands or instructions) during execution of instructions by the processor(s) 1110.

Computing system 1100 can include one or more read only memories (ROMs) 1120 or other static storage device 1125 coupled to the bus 1105 for storing static information and instructions for the processor(s) 1110. Storage devices 1125 can include any storage device, such as a solid state device, magnetic disk or optical disk, which can be coupled to the data bus 1105 to persistently store information and instructions.

Computing system 1100 can be coupled via the data bus 1105 to one or more output devices 1135, such as speakers or displays (e.g., liquid crystal display or active matrix display) for displaying or providing information to a user. Input devices 1130, such as keyboards, touch screens or voice interfaces, can be coupled to the data bus 1105 for communicating information and commands to the processor(s) 1110. Input device 1130 can include, for example, a touch screen display (e.g., output device 1135). Input device 1130 can include a cursor control, such as a mouse, a trackball, or cursor direction keys, for communicating direction information and command selections to the processor(s) 1110 for controlling cursor movement on a display.

The processes, systems and methods described herein can be implemented by the computing system 1100 in response to the processor 1110 executing an arrangement of instructions provided via main memory 1115. Such instructions can be read into main memory 1115 from another computer-readable medium, such as the storage device 1125. Execution of the arrangement of instructions contained in main memory 1115 causes the computing system 1100 to perform the illustrative processes described herein. One or more processors 1110 in a multi-processing arrangement can also be employed to execute the instructions contained in main memory 1115. Hard-wired circuitry can be used in place of or in combination with software instructions together with the systems and methods described herein. Systems and methods described herein are not limited to any specific combination of hardware circuitry and software.

Although an example computing system has been described in FIG. 11, the subject matter including the operations described in this specification can be implemented in other types of digital electronic circuitry, or in computer software, firmware, or hardware, including the structures disclosed in this specification and their structural equivalents, or in combinations of one or more of them.

Having now described some illustrative implementations, the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both “A’ and ‘B’. Such references used in conjunction with “comprising” or other open terminology can include additional items. References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any clam elements.

Scope of the systems and methods described herein is thus indicated by the appended claims, rather than the foregoing description. The scope of the claims includes equivalents to the meaning and scope of the appended claims.

What is claimed is:

1. A system comprising:
one or more processors, coupled with memory, to:
identify a request to execute an action associated with a first account identifier of a client system;
select a prompt that corresponds to the action, the prompt structured as text including one or more fields, the prompt identifying a list of compatible actions corresponding to at least one of the client system or the first account identifier;
embed content of the first account identifier into one or more of the fields of the prompt, the content including at least a portion of the text or a least a portion of a metadata;
provide, to a model trained with machine learning, the prompt embedded with the content;
obtain, from the model, a response to the prompt that indicates a recommended action and a second account identifier associated with the recommended action;
validate that the recommended action corresponds to at least one of the compatible actions, and the second account identifier corresponds to the first account identifier; and
execute the recommended action for the first account identifier in response to the validation of the recommended action and the second account identifier.

2. The system of claim 1, wherein the one or more processors further:
construct a vector using the action;
construct a plurality of vectors using the prompt;
compare the vector constructed using the action with the plurality of vectors constructed using the prompt; and
determine, based on the comparison, the list of compatible actions corresponding to the action.

3. The system of claim 1, wherein the one or more processors further:
obtain, from the model, an intent of the prompt;
select, based on the intent, an index from a plurality of indexes; and
provide the index to the model to cause the model to generate a response that includes the index instead of the intent.

4. The system of claim 3, wherein the one or more processors further:
obtain, from the model, a response to the prompt that indicates the recommended action, the second account identifier associated with the recommended action and the index.

5. The system of claim 1, wherein the one or more processors further:
identify a network security parameter of the client system;
compare the network security parameter with the first account identifier and the action; and
determine, based on the comparison, the action is authorized.

6. The system of claim 1, wherein the one or more processors further:
train the model with data from the client system.

7. The system of claim 1, wherein the one or more processors further:
identify, using the model, one or more data points associated with the action;
validate that the one or more data points corresponds to the action; and
execute, using at least one of the one or more data points, the recommended action for the first account identifier in response to the validation of the recommended action and the second account identifier.

8. The system of claim 1, wherein the one or more processors further:
provide, to the model trained with machine learning, the prompt including the content and one or more historical responses to prompts; and
obtain, from the model, a response to the prompt that indicates a recommended action and second account identifier associated with the recommended action.

9. The system of claim 1, wherein the one or more processors further:
format the response to the prompt based on the client system.

10. The system of claim 1, wherein the first account identifier corresponds to a profile data structure of an individual of an organization associated with the client system.

11. The system of claim 1, wherein the action corresponds to a human resources activity, and the compatible actions correspond to human resource activities supported by a service provider system.

12. A method, comprising:
identifying, by one or more processors, a request to execute an action associated with a first account identifier of a client system;
selecting, by one or more processors, a prompt that corresponds to the action, the prompt structured as text including one or more fields, the prompt identifying a list of compatible actions corresponding to at least one of the client system or the first account identifier;
embedding, by one or more processors, content of the first account identifier into one or more of the fields of the prompt, the content including at least a portion of the text or a least a portion of a metadata;
providing, by one or more processors, to a model trained with machine learning, the prompt including the content;
obtaining, by one or more processors, from the model, a response to the prompt that indicates a recommended action and a second account identifier associated with the recommended action;
validating, by one or more processors, that the recommended action corresponds to at least one of the compatible actions and the second account identifier corresponds to the first account identifier; and
executing, by one or more processors, the recommended action for the first account identifier in response to the validation of the recommended action and the second account identifier.

13. The method of claim 12, further comprising:
constructing, by one or more processors, a vector using the action;
constructing, by one or more processors, a plurality of vectors using the prompt;
comparing, by one or more processors, the vector constructed using the action with the plurality of vectors constructed using the prompt; and
determining, by one or more processors, based on the comparison, the list of compatible actions corresponding to the action.

14. The method of claim 12, further comprising:
obtaining, by one or more processors, from the model, an intent of the prompt;
selecting, by one or more processors, based on the intent, an index from a plurality of indexes; and
providing, by one or more processors, the index to the model to cause the model to generate a response that includes the index instead of the intent.

15. The method of claim 14, further comprising:
obtaining, by one or more processors, from the model, a response to the prompt that indicates the recommended action, the second account identifier associated with the recommended action and the index.

16. The method of claim 12, further comprising:
identifying, by one or more processors, a network security parameter of the client system;
comparing, by one or more processors, the network security parameter with the first account identifier and the action; and
determining, by one or more processors, based on the comparison, the action is authorized.

17. The method of claim 12, comprising:
identifying, by one or more processors, from the model, one or more data points associated with the recommended action;
validating, by one or more processors, that the one or more data points corresponds to the recommended action; and
executing, by one or more processors, using at least one of the one or more data points, the recommended action for the first account identifier in response to the validation of the recommended action and the second account identifier.

18. The method of claim 12, further comprising:
providing, to the model trained with machine learning, the prompt including the content and one or more historical responses to prompts; and
obtaining, by one or more processors, from the model trained with machine learning, a response to the prompt that indicates a recommended action and the second account identifier associated with the recommended action.

19. The method of claim 12, comprising:
providing, by one or more processors, to the model trained with machine learning, the prompt including the content and one or more historical responses to prompts; and
obtaining, by one or more processors, from the model, a response to the prompt that indicates a recommended action and a second account identifier associated with the recommended action.

20. A non-transitory computer-readable medium comprising instructions that, when executed by one or more processors coupled with memory, cause the one or more processors to:
identify a request to execute an action associated with a first account identifier of a client system;
select a prompt that corresponds to the action, the prompt structured as text including one or more predetermined fields and one or more dynamic fields, the prompt identifying a list of compatible actions corresponding to at least one of the client system or the first account identifier;
embed content of the first account identifier into one or more of the dynamic field of the prompt, the content including at least a portion of the text or a least a portion of a metadata;
provide, to a model trained with machine learning, the prompt including the content;
obtain, from the model, a response to the prompt that indicates a recommended action and second account identifier associated with the recommended action;
validate that the recommended action corresponds to at least one of the compatible actions and the second account identifier corresponds to the first account identifier; and
execute the recommended action for the first account identifier in response to the validation of the recommended action and the second account identifier.
